(19) United States
(12) Patent Application Publication
(10) Pub. No.: US 2015/0367497 A1
(43) Pub. Date: Dec. 24, 2015

(54) ELECTRICAL POWER TOOL

(71) Applicant: MAKITA CORPORATION, Anjo-shi, Aichi (JP)

(72) Inventors: Miyabi ITO, Anjo-shi (JP); Kazuo MURAMATSU, Anjo-shi (JP)

(21) Appl. No.: 14/762,634

(22) PCT Filed: Dec. 25, 2013
(86) PCT No.: PCT/JP2013/084603

§ 371 Date: Jul. 22, 2015

(30) Foreign Application Priority Data
Feb. 1, 2013 (JP) 2013-018882

(51) Int. Cl. B25F 5/02

(52) U.S. Cl. CPC B25F 5/02

(57) ABSTRACT

A driver drill may have two battery attachment portions to which two rechargeable batteries can be attached. Therefore, the driver drill can meet a need for an increased voltage or an increased discharge capacity. Further, the two battery attachment portions may be constructed as slide-fitting battery attachment portions. A combined gravity center of the rechargeable batteries attached to the first and second battery attachment portions may be positioned on a vertical line through a gravity center of a tool main body in a condition in which the two rechargeable batteries are detached therefrom.

### TECHNICAL FIELD

The present invention relates to a handheld electrical power tool represented by a driver drill that is used to perform a screw tightening operation or a drilling operation while it is held in hand.

### BACKGROUND ART

Conventionally, a handheld electrical power tool used to perform a screw tightening operation or a drilling operation while it is held in hand is known (for example, JP 2003-191113). Examples of the handheld electrical power tool are an electrical driver, an electrical drill, a driver drill, a vibratory driver drill and an impact driver drill. This type of electrical power tool includes an electrical motor to function as a drive source. The motor is received in a tool main body of the electrical power tool. A grip portion to be gripped by a worker is formed in an outer housing of the power tool. A deceleration mechanism, a power transmission interruption mechanism and other such mechanisms are disposed in a front portion of the tool main body. A spindle is projected forward from these mechanisms. The spindle is configured such that a rotational driving force of a motor shaft can be transmitted thereto via these mechanisms. The spindle has a tool bit retainer portion to which a tool bit is attached. Further, this type of electrical power tool includes a rechargeable battery generally called a battery pack to function as a power supply. The rechargeable battery is configured to be charged using a special battery charger and then be attached to the tool main body. In this type of electrical power tool, the rechargeable battery is generally attached to a rear end portion of the tool main body.

### SUMMARY OF THE INVENTION

In the electrical power tool described above, with regard to electrical power supplied from the rechargeable battery, there is a need for an increased voltage or an increased discharge capacity. Therefore, in order to meet such a need, for example, an electrical power tool to which two general-purpose rechargeable batteries can be attached has been developed. However, when the two rechargeable batteries are attached to the tool main body without any change in the tool main body, the two rechargeable batteries attached thereto may cause an imbalance in weight of the electrical power tool. This may reduce operability of the electrical power tool.

The present invention has been made in view of the circumstances. It is an object of the present invention to provide a handheld electrical power tool that is used to perform a screw tightening operation or other such operations while it is held in hand, in which a need for an increased voltage and an increased discharge capacity in the electrical power tool can be met while an operability of the electrical power tool can be restricted from being deteriorated.

In order to solve the above-mentioned problem, an electrical power tool according to the present invention has the following means. In a first aspect of the present invention, an electrical power tool may includes battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft, wherein the battery attachment portions comprise two battery attachment portions that are juxtaposed in a longitudinal direction in which the motor shaft extends.

Because the electrical power tool in the first aspect has the two battery attachment portions, the two rechargeable batteries can be attached thereto. Therefore, the electrical power tool can meet a need for an increased voltage or an increased discharge capacity. Further, because the two battery attachment portions in the electrical power tool in the first aspect are juxtaposed in the longitudinal direction in which the motor shaft extends, volume of the rechargeable batteries attached to the battery attachment portions can be longitudinally spread.

Further, because the motor shaft of the electrical power tool extends in the longitudinal direction, the volume of the rechargeable batteries may be aligned with the direction in which the motor shaft extends. Thus, the volume of the rechargeable batteries may be elongated in the direction in which the motor shaft of the electrical power tool extends. Therefore, the electrical power tool having the rechargeable batteries can be reduced in size as a whole. As a result, when the electrical power tool is used to perform a screw tightening operation or other such operations while it is held in hand, good usability of the electrical power tool can be prevented from being reduced.

In a second aspect of the present invention, an electrical power tool may include battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft, wherein the battery attachment portions comprise two battery attachment portions that are positioned symmetrically with respect to an axis of the motor shaft.

In a third aspect of the present invention, an electrical power tool may include battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft, wherein the battery attachment portions comprise two battery attachment portions that are positioned such that axes lines along which the rechargeable batteries are attached thereto by slide-fitting are positioned in parallel to each other.

In a fourth aspect of the present invention, an electrical power tool may include battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft, wherein the battery attachment portions comprise two battery attachment portions that are positioned such that directions in which the rechargeable batteries are attached thereto by slide-fitting are respectively intersect with an axis line of the motor shaft.

In a fifth aspect of the present invention, an electrical power tool may include battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft, wherein the battery attachment portions have a rotation axis that extends in an elongating direction of the handle portion and are held on the handle portion such that a relative direction thereof relative to the handle portion can be changed.

### BRIEF DESCRIPTION OF THE DRAWINGS

FIG. 1 is a perspective view of a driver drill of a first embodiment, which view shows an external appearance thereof.

FIG. 2 is a side view of the driver drill shown in FIG. 1.

FIG. 3 is a plan view of the driver drill shown in FIG. 1.

FIG. 4 is a bottom view of the driver drill shown in FIG. 1.

FIG. 5 is an internal structural diagram of the driver drill shown in FIG. 1, which view shows a halved internal structure.

FIG. 6 is a sectional view taken along line (VI)-(VI) of FIG. 5, which view shows an internal structure.

FIG. 7 is a perspective view of a rechargeable battery to be attached to a battery attachment portion by sliding the same.

FIG. 8 is an enlarged view of a battery terminal connecting portion shown in FIG. 4.

FIG. 9 is a schematic circuit diagram of an electrical motor, which schematically shows a circuit structure thereof.

FIG. 10 is a perspective view of a driver drill of a second embodiment, which view shows an external appearance thereof.

FIG. 11 is a side view of the driver drill shown in FIG. 10.

FIG. 12 is a plan view of the driver drill shown in FIG. 10.

FIG. 13 is a bottom view of the driver drill shown in FIG. 10.

FIG. 14 is a perspective view of a driver drill of a third embodiment, which view shows an external appearance thereof.

FIG. 15 is a side view of the driver drill shown in FIG. 14.

FIG. 16 is a plan view of the driver drill shown in FIG. 14.

FIG. 17 is a bottom view of the driver drill shown in FIG. 14.

FIG. 18 is a perspective view of a driver drill of a fourth embodiment, which view shows an external appearance thereof.

FIG. 19 is a side view of the driver drill shown in FIG. 18.

FIG. 20 is a plan view of the driver drill shown in FIG. 18.

FIG. 21 is a bottom view of the driver drill shown in FIG. 18.

FIG. 22 is a perspective view of a driver drill of a fifth embodiment, which view shows an external appearance thereof.

FIG. 23 is a side view of the driver drill shown in FIG. 22.

FIG. 24 is a plan view of the driver drill shown in FIG. 22.

FIG. 25 is a bottom view of the driver drill shown in FIG. 22.

FIG. 26 is a perspective view of a driver drill of a sixth embodiment, which view shows an external appearance thereof.

FIG. 27 is a side view of the driver drill shown in FIG. 26.

FIG. 28 is a plan view of the driver drill shown in FIG. 26.

FIG. 29 is a front elevation view of the driver drill shown in FIG. 26.

FIG. 30 is a perspective view of a driver drill of a seventh embodiment, which view shows an external appearance thereof.

FIG. 31 is a side view of the driver drill shown in FIG. 30.

FIG. 32 is a plan view of the driver drill shown in FIG. 30.

FIG. 33 is a front elevation view of the driver drill shown in FIG. 30.

FIG. 34 is a perspective view of a driver drill of an eighth embodiment, which view shows an external appearance thereof.

FIG. 35 is a side view of the driver drill shown in FIG. 34.

FIG. 36 is a plan view of the driver drill shown in FIG. 34.

FIG. 37 is a front elevation view of the driver drill shown in FIG. 34.

FIG. 38 is a rear elevation view of the driver drill shown in FIG. 34.

FIG. 39 is a bottom view of the driver drill shown in FIG. 34.

FIG. 40 is a perspective view of a driver drill of a ninth embodiment, which view shows an external appearance thereof.

FIG. 41 is a side view of the driver drill shown in FIG. 40.

FIG. 42 is a plan view of the driver drill shown in FIG. 40.

FIG. 43 is a front elevation view of the driver drill shown in FIG. 40.

FIG. 44 is a rear elevation view of the driver drill shown in FIG. 40.

FIG. 45 is a bottom view of the driver drill shown in FIG. 40.

FIG. 46 is a perspective view of a driver drill of a tenth embodiment, which view shows an external appearance thereof.

FIG. 47 is a side view of the driver drill shown in FIG. 46.

FIG. 48 is an internal structural diagram of the driver drill shown in FIG. 46, which view shows a halved internal structure.

FIG. 49 is an enlarged internal structural diagram of a portion (XXXXIX) shown in FIG. 48.

FIG. 50 is a sectional view taken along line (XXXXX)-(XXXXX) of FIG. 5, which view shows an internal structure.

FIG. 51 is an enlarged top plan view of a rotation mechanism.

FIG. 52 is a sectional view which shows a rotation structure of the rotation mechanism.

FIG. 53 is a perspective view of the driver drill shown in FIG. 46 in which a battery attachment portion is rotated by degrees, which view shows an external appearance thereof.

### MODES FOR CARRYING OUT THE INVENTION

### First Embodiment

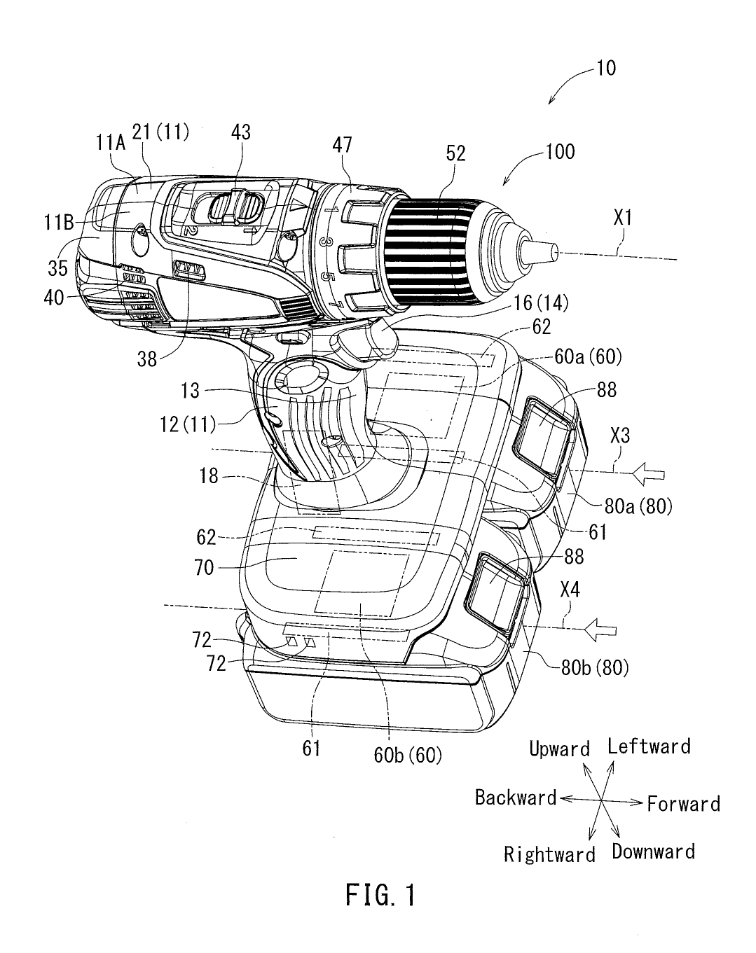

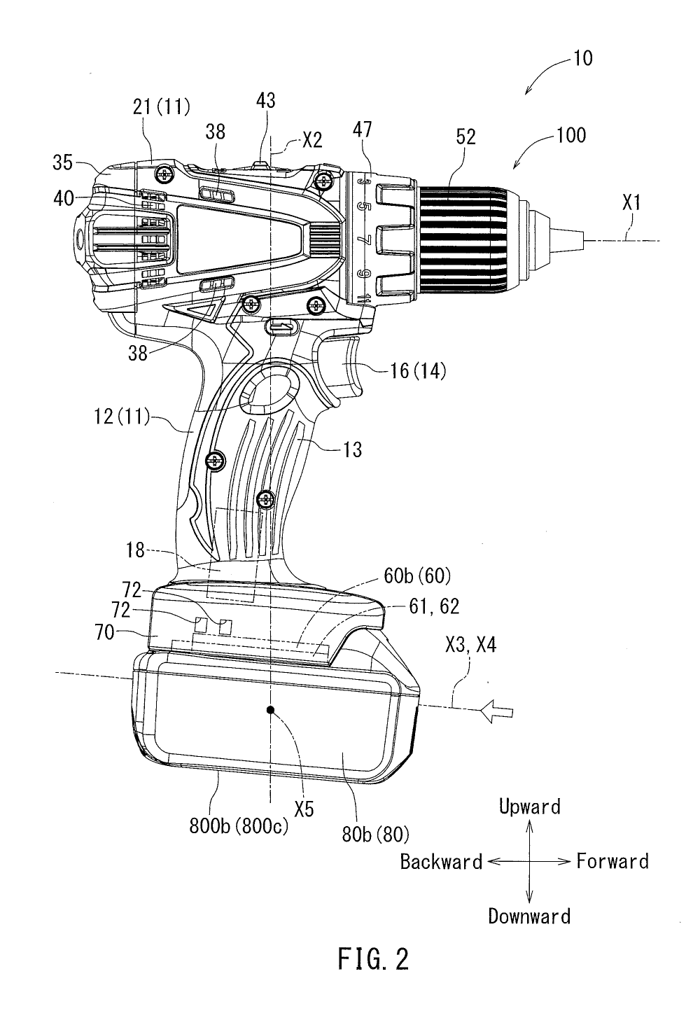

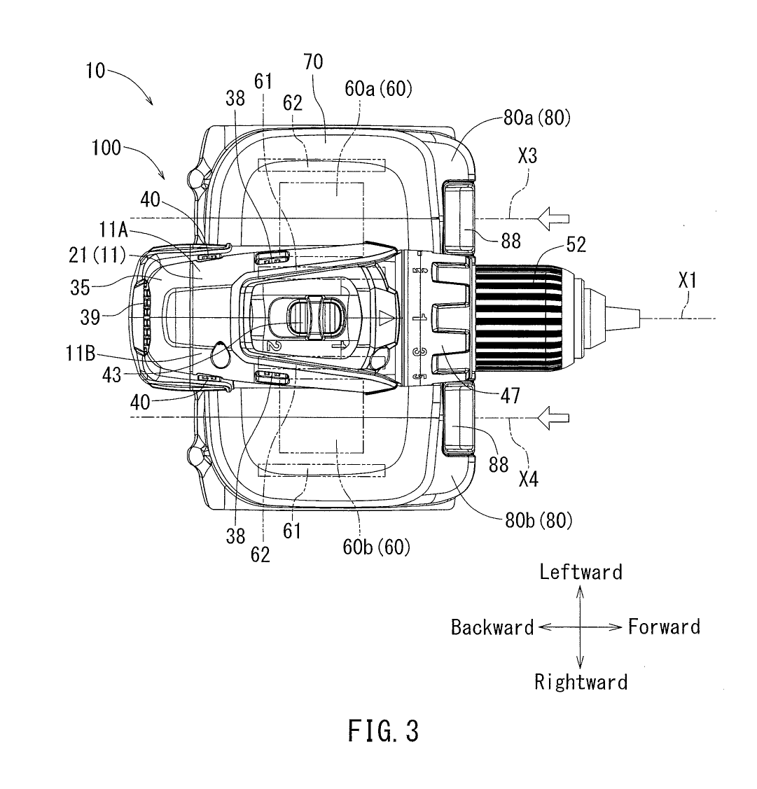

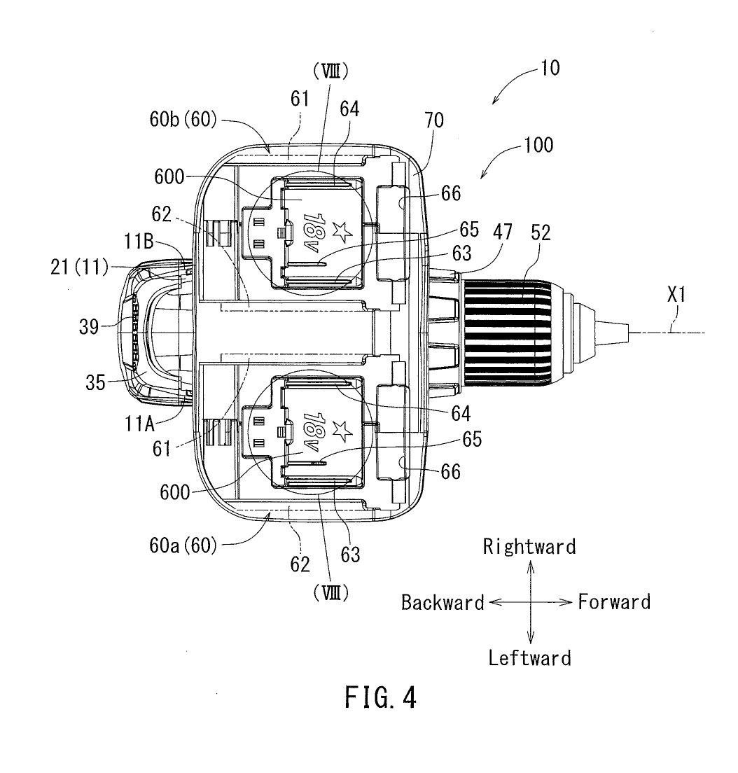

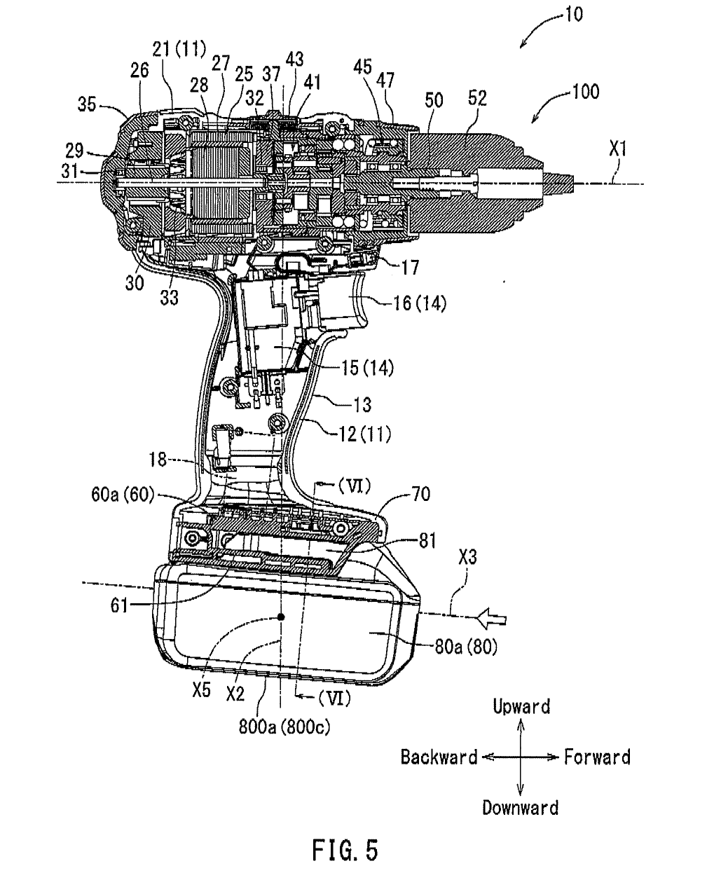

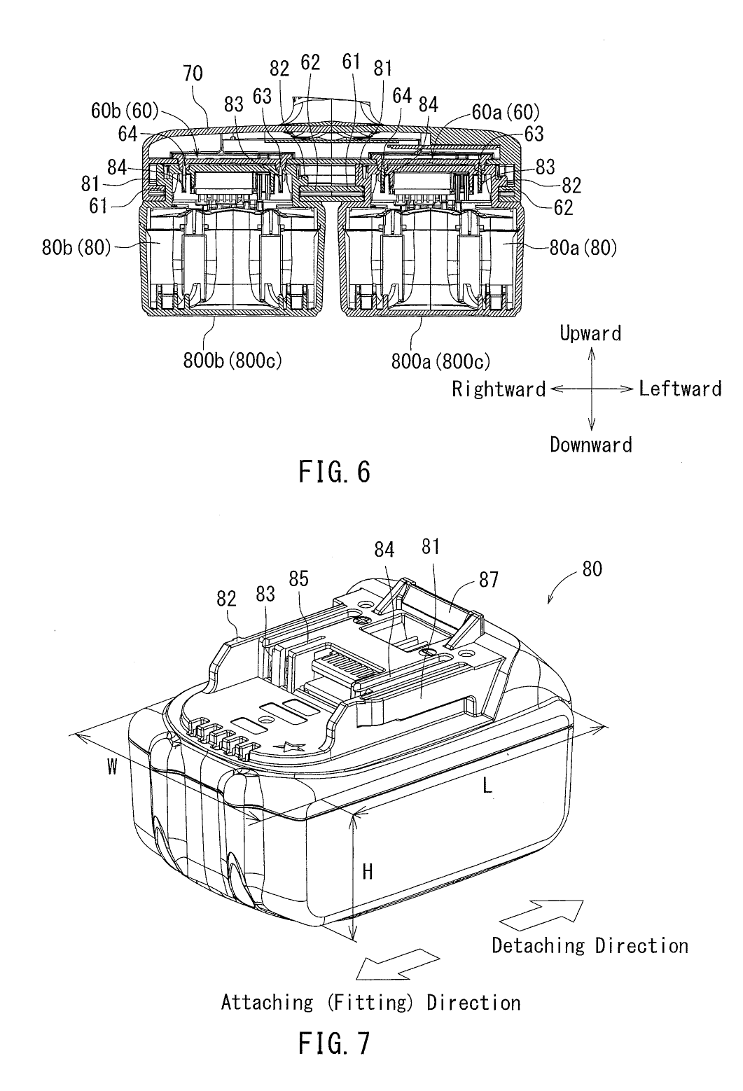

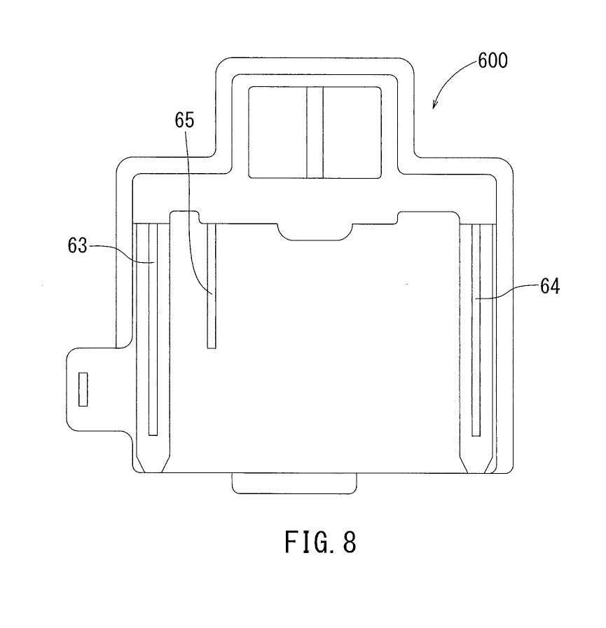

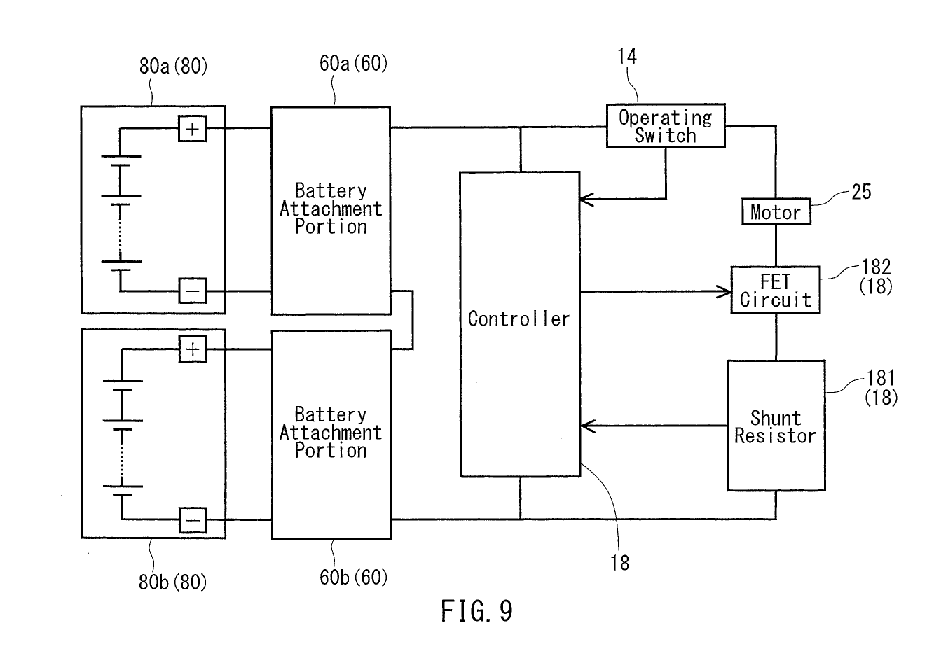

Next, a first embodiment of the present invention will be described with reference to FIGS. 1 to 9. In FIG. 1, a reference numeral 10 shows a driver drill corresponding to an electrical power tool according to the present invention. Further, FIG. 1 is a perspective view of the driver drill 10 of the first embodiment, which view shows an external appearance thereof. FIG. 2 is a side view of the driver drill 10 shown in FIG. 1. FIG. 3 is a plan view of the driver drill 10 shown in FIG. 1. FIG. 4 is a bottom view of the driver drill 10 shown in FIG. 1. FIG. 5 is an internal structural diagram of the driver drill 10 shown in FIG. 1, which view shows a halved internal structure. FIG. 6 is a sectional view taken along line (VI)-(VI) of FIG. 5, which view shows an internal structure. FIG. 7 is a perspective view of rechargeable batteries 80 to be attached to battery attachment portions 60 by sliding the same. FIG. 8 is an enlarged view of a battery terminal connecting portion 600 shown in FIG. 4. FIG. 9 is a schematic circuit diagram of an electrical motor 25, which schematically shows a circuit structure thereof.

In the following description, the driver drill 10 may be described with reference to directions shown in the drawings. Further, a longitudinal direction, a vertical direction and a lateral direction of the driver drill 10 may respectively determined with reference to a position of a motor shaft 26. A direction in which the motor shaft 26 extends may correspond to the longitudinal direction of the driver drill 10. In particular, a side of the motor shaft 26 on which a spindle 50 is attached may relatively be defined as a front side of the driver drill 10. Further, a side of a handle portion 13 on which the motor shaft 26 is positioned may relatively be referred to as an upper side of the driver drill 10. In other words, a side of the handle portion 13 on which the rechargeable batteries 80 are positioned may be defined as a lower side of the driver drill 10. Further, the lateral direction of the driver drill 10 may be defined based on the longitudinal direction and the vertical direction thus defined.

A reference sign X1 shows an axis line of the motor shaft 26. The driver drill 10 may be a handheld screw tightening tool that is used to perform a screw tightening operation or other such operations while a user holds the same in hand. The driver drill 10 may correspond to the electrical power tool according to the present invention. The driver drill 10 may be a high-power driver drill using electrical power of 36 V. The driver drill 10 may be the electrical power tool that is configured to be driven by the electrical power supplied from the rechargeable batteries 80. Therefore, the driver drill 10 may have a tool main body 100 to which the rechargeable batteries 80 may be attached by sliding the same.

That is, the driver drill 10 may be configured to generate a rotational driving force by an electrical motor 25 driven by the electrical power supplied from the rechargeable batteries 80. The rotational driving force may be transmitted to the spindle 50 via a deceleration mechanism and a power transmission interruption mechanism which will be hereinafter described. The spindle 50 may have a chuck 52 to which a desired bit (not shown) is attached. Further, the bit that is not shown may be referred to as a tool bit of the present invention. Further, the chuck 52 may be referred to as a tool bit attaching portion. The tool main body 100 may generally be composed of a housing 11 and various internal components. The housing 11 may be formed by joining halved to a left housing 11A and a right housing 11B that are halved.

The housing 11 may be functionally divided into a grip housing portion 12 and a main housing portion 21. The grip housing portion 12 may form the handle portion 13 of the driver drill 10. The handle portion 13 may have a shape resembling a grip of a gun. Therefore, the grip housing portion 12 may be appropriately shaped so as to be vertically elongated. The grip housing portion 12 may have an operating switch 14 that is attached to an upper portion thereof. As shown in FIG. 5, the operating switch 14 may have a switch main body 15 and an operation button portion 16. The switch main body 15 may be received within and held by the grip housing portion 12. The switch main body 15 may be a contact switch that is widely used. The operation button portion 16 may be supported by the grip housing portion 12 so as to move in the longitudinal direction. The operation button portion 16 may be configured to close contacts of the switch main body 15 when it is pushed in a gripping direction of the handle portion 13. The switch main body 15 of which the contacts are closed may input a switch-on signal to a controller 18.

When the operation button portion 16 is not pushed, the operation button portion 16 may be restored by a biasing spring that is not shown, so as to open the contacts of the switch main body 15. Further, the handle portion 13 may have a desired grip shape such that the user can grasp the same by the middle finger, the medicinal finger and the little finger and can trigger the operating switch 14 by the index finger. Further, the grip housing portion 12 may have a LED illuminating device 17 that is positioned on an upper and forward end portion thereof. The LED illuminating device 17 may be configured to illuminate a working area when the operating switch 14 is switched on.

The main housing portion 21 may be positioned on and integrally connected to the grip housing portion 12. The main housing portion 21 may be appropriately shaped so as to be longitudinally elongated. The various internal components for driving the driver drill 10 may be received in the main housing portion 21. The main housing portion 21 may have a rear cover 35 that is attached to a rear end portion thereof and is configured to close an opening formed in the rear end portion thereof. The main housing portion 21 may contain the electrical motor 25, a planetary gear deceleration mechanism 41 and a clutch mechanism 45 therein. These devices may be arranged from a rear portion of the main housing portion 21 forward in order. The electrical motor 25 may rotationally drive the motor shaft 26. The drive shaft 26 may be rotatably supported by a rear bearing 31 and a front bearing 32.

The rear bearing 31 may be supported by the rear cover 35. Further, the front bearing 32 may be held by the main housing portion 21 via a bracket 37. Thus, the motor shaft 26 may be positioned on an upper side of the handle portion 13 so as to be longitudinally elongated. The electrical motor 25 may rotationally drive the motor shaft 26 by the electrical power. The electrical motor 25 may be a so-called brushed motor and have a stator 27, a rotor 28 and a commutator 29. The stator 27 may be a permanent magnet that is held by the main housing portion 21. The rotor 28 may be composed of a coiled winding. The rotor 28 may have a rotating shaft which functions as the motor shaft 26. The motor shaft 26 may have a cooling fan 33 that is attached thereto and is positioned behind the rotor 28.

A carbon retainer 30 for retaining carbon brushes may be positioned behind the cooling fan 33. The carbon retainer 30 may be held by the main housing portion 21. The cooling fan 33 attached to the motor shaft 26 may blow upon rotation of the motor shaft 26. In order to blow air, ambient air may be aspirated via front suction ports 38 formed in the main housing portion 21, rear suction ports 39 formed in the rear cover 35 and vent holes 72 formed in an enlarged coupling portion 70 which will be hereinafter described. The ambient air thus aspirated may be introduced into the housing 11 in order to cool the various components contained therein and then be discharged to the atmosphere from discharge ports 40 formed in the main housing portion 21.

The deceleration mechanism and the power transmission interruption mechanism may be positioned in front of the electrical motor 25. Further, the spindle 50 may be positioned in front of the deceleration mechanism and the power transmission interruption mechanism. The spindle 50 may output a rotational driving force transmitted via the deceleration mechanism and the power transmission interruption mechanism. That is, the planetary gear deceleration mechanism 41 as the deceleration mechanism and the clutch mechanism 45 as the power transmission interruption mechanism may be positioned in front of the electrical motor 25. The planetary gear deceleration mechanism 41 may function to reduce the rotational driving force of the motor shaft 26 of the electrical motor 25. Therefore, the planetary gear deceleration mechanism 41 may be configured such that the rotational driving force of the motor shaft 26 can be introduced thereinto. Further, the planetary gear deceleration mechanism 41 may be configured to output the reduced rotational driving force of the motor shaft 26.

The structure of the planetary gear deceleration mechanism 41 may be shown by various patent documents. An example of the patent documents may be Japanese Patent Application No. 2011-83935 (Japanese Laid-Open Patent Publication No. 2012-218088). This patent document teaches a vibratory driver drill having a planetary gear deceleration mechanism as a deceleration mechanism. Further, a speed change lever 43 of the planetary gear deceleration mechanism 41 may be attached to an upper portion of the main housing portion 21. The speed change lever 43 may be configured to change a speed reduction ratio of the planetary gear deceleration mechanism 41 to a desired ratio by sliding the same in the longitudinal direction. The clutch mechanism 45 may configured to interrupt transmission of the rotational driving force from the planetary gear deceleration mechanism 41 to the spindle 50 when a rotation torque output from the planetary gear deceleration mechanism 41 exceeds or equal to a predetermined rotation torque.

The structure of the clutch mechanism 45 may be shown by various patent documents. An example of the patent documents may be Japanese Patent Application No. 2011-83935 (Japanese Laid-Open Patent Publication No. 2012-218088) described above. This patent document teaches a vibratory driver drill having a clutch mechanism as a power transmission interruption mechanism. Further, a torque adjustment ring 47 of the clutch mechanism 45 may be attached to a front end of the main housing portion 21. The torque adjustment ring 47 may be configured to change the rotation torque to a desired rotation torque value by rotating the same such that the clutch mechanism 45 can interrupt the transmission of the rotational driving force based on the rotation torque value thus changed. The spindle 50 may be positioned in front of the clutch mechanism 45. The spindle 50 may output the rotational driving force transmitted from the motor shaft 26 of the electrical motor 25. As previously described, the spindle 50 may have the chuck 52 attached thereto.

The battery attachment portions 60 may be attached to a lower portion of the grip housing portion 12 described above. The battery attachment portions 60 may be configured such that the rechargeable batteries 80 can be attached thereto by sliding the same. The grip housing portion 12 may have the enlarged coupling portion 70 that is configured to hold the battery attachment portions 60 to which two rechargeable batteries 80a and 80b are attached. As shown in FIG. 4, the enlarged coupling portion 70 may have two battery attachment portions 60a and 60b formed therein. The rechargeable batteries 80a and 80b may respectively be attached to the two battery attachment portions 60a and 60b by sliding the same.

As shown in FIG. 7, the rechargeable batteries 80a and 80b may respectively be the widely-used rechargeable batteries 80 each of which generates the electrical power of 18 V. The rechargeable batteries 80 may be slide-fitting rechargeable batteries that can be attached to the battery attachment portions 60 by sliding the same. Therefore, each of the rechargeable batteries 80 may have a slide-fitting mechanism and an electrically connecting mechanism that are formed in an upper surface (a connecting terminal formation surface) thereof. As shown in FIG. 7, a pair of slide guide portions 81 and 82 as the slide-fitting mechanism may be formed in the upper surface of each of the rechargeable batteries 80. Further, a positive terminal 83, a negative terminal 84 and a signal terminal 85 as the electrically connecting mechanism may be formed in the upper surface of each of the rechargeable batteries 80.

Each of the rechargeable batteries 80 may have a male hook 87 that is foamed in the upper surface thereof, so that when the rechargeable batteries 80 are attached to the battery attachment portions 60 by slide-fitting and electrically connected thereto, the rechargeable batteries 80 can be engaged with and locked to the battery attachment portions 60. Further, each of the rechargeable batteries 80 may have a push button 88 that is formed in a side corresponding to a detaching direction thereof in order to manipulate the male hook 87. The push button 88 may be associated with the male hook 87. Upon pressing the push button 88, the male hook 87 may be activated and retracted into each of the rechargeable batteries 80. As a result, the rechargeable batteries 80 may be disengaged from the battery attachment portions 60, so that the rechargeable batteries 80 can be removed from the battery attachment portions 60.

The reference L described in FIG. 7 shows a length of each of the rechargeable batteries 80. Further, the reference W described in FIG. 7 shows a width of each of the rechargeable batteries 80. Also, the reference H described in FIG. 7 shows a height of each of the rechargeable batteries 80. That is, each of the rechargeable batteries 80 may have a shape of a substantially rectangular parallelepiped and having a magnitude relation of [the length L>the width W>the height H].

Next, the battery attachment portions 60 to which the rechargeable batteries 80 are attached by sliding the same will be described. As shown in FIGS. 4 and 8, the battery attachment portions 60 may have a mechanism that allows the rechargeable batteries 80 to be attached thereto. Therefore, each of the battery attachment portions 60 may have an attaching mechanism corresponding to the rechargeable batteries 80. In particular, as shown in FIGS. 4 and 8, each of the battery attachment portions 60 may have a slide-fitting mechanism that allows each of the rechargeable batteries 80 to be slide-fitted thereto and an electrically connecting mechanism that allows each of the rechargeable batteries 80 to be electrically connected thereto. As shown in FIG. 4, each of the battery attachment portions 60 may have a pair of slide guide acceptors 61 and 62 as the slide-fitting mechanism.

As shown in FIG. 8, each of the battery attachment portions 60 may have a battery terminal connecting portion 600 having a positive terminal 63, a negative terminal 64 and a signal terminal 65 which may function as the electrically connecting mechanism. Further, as shown in FIGS. 4 and 7, when the rechargeable batteries 80 are electrically connected to the battery attachment portions 60 by slide-fitting, the rechargeable batteries 80 may be locked to the battery attachment portions 60. That is, each of the battery attachment portions 60 may have a female portion (recess) 66 into which the male hook 87 of each of the rechargeable batteries 80 in this condition is fitted. The rechargeable batteries 80a and 80b attached to the first and second battery attachment portions 60a and 60b may be controlled by the controller 18. That is, as shown in the schematic circuit diagram of FIG. 9, the rotational driving force generated by the electrical motor 25 of the driver drill 10 may be controlled by the controller 18.

The controller 18 may be configured to receive input signals from the operating switch 14 and a shunt resistor 181 (a portion of the controller 18) and to transmit an output signal to an FET (field-effect transistor) circuit 182 (a portion of the controller 18). Thus, the controller 18 may control the rotational driving force of the electrical motor 25. Further, the rechargeable batteries 80a and 80b attached to the first and second battery attachment portions 60a and 60b may be connected in series. Due to the series connection, the electrical power of “36 V” can be supplied from the rechargeable batteries 80a and 80b via the first and second battery attachment portions 60a and 60b. Further, the controller 18 may have two controlling functions incorporated thereinto, i.e., a function to control the driving force of the electrical motor 25 as usual and a function to control the electrical power supplied from the two rechargeable batteries 80a and 80b attached to the two battery attachment portions 60a and 60b. The controller 18 may be positioned in a range bridging the enlarged coupling portion 70 and the grip housing portion 12.

Next, the first battery attachment portion 60a and the second battery attachment portion 60b attached to the enlarged coupling portion 70 will be described with reference to FIG. 4 and other figures. Further, as shown in the drawings, the enlarged coupling portion 70 may be appropriately enlarged vertically and horizontally so as to receive the two battery attachment portions 60 (60a and 60b). The first battery attachment portion 60a and the second battery attachment portion 60b may be attached to the enlarged coupling portion 70 in a juxtapositional relation in which they are laterally juxtaposed therein. Therefore, the slide-fitting directions of the rechargeable batteries 80a and 80b may be determined such that both of the rechargeable batteries 80a and 80b are respectively attached to the first and second battery attachment portions 60a and 60b by sliding the same from before backward. That is, the first battery attachment portion 60a and the second battery attachment portion 60b may be positioned symmetrically with respect to the axis of the motor shaft 26. A broken line shown by a reference sign X3 in the drawings shows an axis line along which the rechargeable battery 80a is attached to the first battery attachment portion 60a by slide-fitting.

A broken line shown by a reference sign X4 in the drawings shows an axis line along which the rechargeable battery 80b is attached to the second battery attachment portion 60b by slide-fitting. Further, each of the first and second battery attachment portions 60a and 60b may have the same attaching mechanism as the battery attachment portions 60 previously described. The axis line X3 and the axis line X4 may be positioned in parallel to each other. That is, the battery attachment portions 60a and 60b of the first embodiment may be attached to the enlarged coupling portion 70 positioned in the lower portion of the grip housing portion 12 such that the two rechargeable batteries 80a and 80b are attached thereto by sliding the same in parallel to each other. In other words, sliding directions of the rechargeable batteries 80a and 80b with respect to the first and second battery attachment portions 60a and 60b may be directed in parallel to each other as indicated by the reference sign X3 and the reference sign X4 in the drawings. Further, the first and second battery attachment portions 60a and 60b may respectively be attached to the grip housing portion 12 symmetrically with respect to the axis line X1 of the motor shaft 16.

The two rechargeable batteries 80a and 80b attached to the first and second battery attachment portions 60a and 60b may be positioned such that a combined gravity center X5 thereof is positioned on a vertical line X2 through a gravity center of the tool main body 100 in a condition in which the two rechargeable batteries 80a and 80b are detached therefrom. In other words, a position of the vertical line X2 through the gravity center of the tool main body 100 may substantially be maintained before and after the two rechargeable batteries 80a and 80b are attached to the tool main body 100. Further, the vertical line X2 through the gravity center of the tool main body 100 may be aligned with a direction of gravitational force, which alignment may be considered to be well-balanced back and forth in weight of the driver drill 10 when the user grasps the handle portion 13. Further, the vent holes 72 may be formed in a side surface of the enlarged coupling portion 70 such that the inside and the outside of the enlarged coupling portion 70 are communicated with each other. The vent holes 72 may function to aspirate the ambient air therethrough due to the blowing of the cooling fan 33. The ambient air introduced into the inside of the enlarged coupling portion 70 through the vent holes 72 may be successively sent from the inside of the enlarged coupling portion 70 to the inside of the grip housing portion 12 and the inside of the main housing portion 21 while cooling the controller 18 described above. The wind thus sent may be discharged to the atmosphere from discharge ports 40.

According to the driver drill 10 of the first embodiment, the following effects may be produced. That is, the driver drill 10 of the above-described embodiment can be used with an increased voltage or an increased discharge capacity because the driver drill 10 may have the two battery attachment portions 60a and 60b to which the two rechargeable batteries 80a and 80b can be attached. Further, in the driver drill 10, the two battery attachment portions 60a and 60b may be constructed as slide-fitting battery attachment portions. Therefore, the two battery attachment portions 60a and 60b can be compatible with the slide-fitting rechargeable batteries 80a and 80b that can be attached thereto by sliding the same. Thus, the driver drill 10 can meet the need for the increased voltage and the increased discharge capacity using the widely-used rechargeable batteries 80.

According to the driver drill 10 of the above-described embodiment, the first and second battery attachment portions 60a and 60b may respectively be positioned symmetrically with respect to the axis line X1 of the motor shaft 26. As a result, even when the rechargeable batteries 80a and 80b are attached to the first and second battery attachment portions 60a and 60b, the driver drill 10 can be laterally balanced in weight. Therefore, when the driver drill 10 is used to perform the screw tightening operation or other such operations while it is held in hand, good usability of the driver drill 10 can be maintained due to an excellent lateral balance in weight. Further, according to the driver drill 10 of the above-described embodiment, the combined gravity center X5 of the rechargeable batteries 80a and 80b attached to the first and second battery attachment portions 60a and 60b may be positioned on the vertical line X2 through the gravity center of the tool main body 100 in the condition in which the two rechargeable batteries 80a and 80b are detached therefrom. Therefore, even in a condition in which the rechargeable batteries 80a and 80b are attached to the tool main body 100, inherent good usability of the driver drill 10 can not be reduced.

In the driver drill 10 of the above-described embodiment, the two battery attachment portions 60a and 60b may respectively be positioned such that lower surfaces 800a and 800b of the two rechargeable batteries 80a and 80b attached to the two battery attachment portions 60a and 60b by slide-fitting may be flush with each other. As a result, the lower surfaces 800a and 800b of the two rechargeable batteries 80a and 80b attached to the battery attachment portions by slide-fitting may form common lower surfaces 800c that are flush with each other. Therefore, when there is a need to temporarily store the driver drill 10, the driver drill 10 can be stably stored by placing the same on a storage surface with the common lower surfaces 800c facing the storage surface.

### Second Embodiment

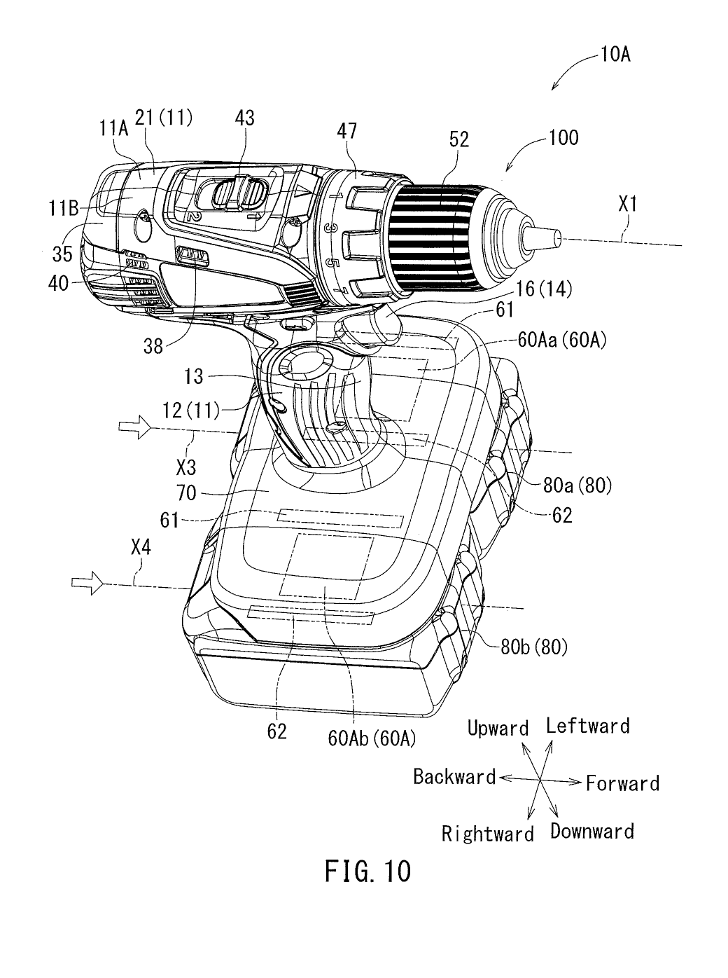

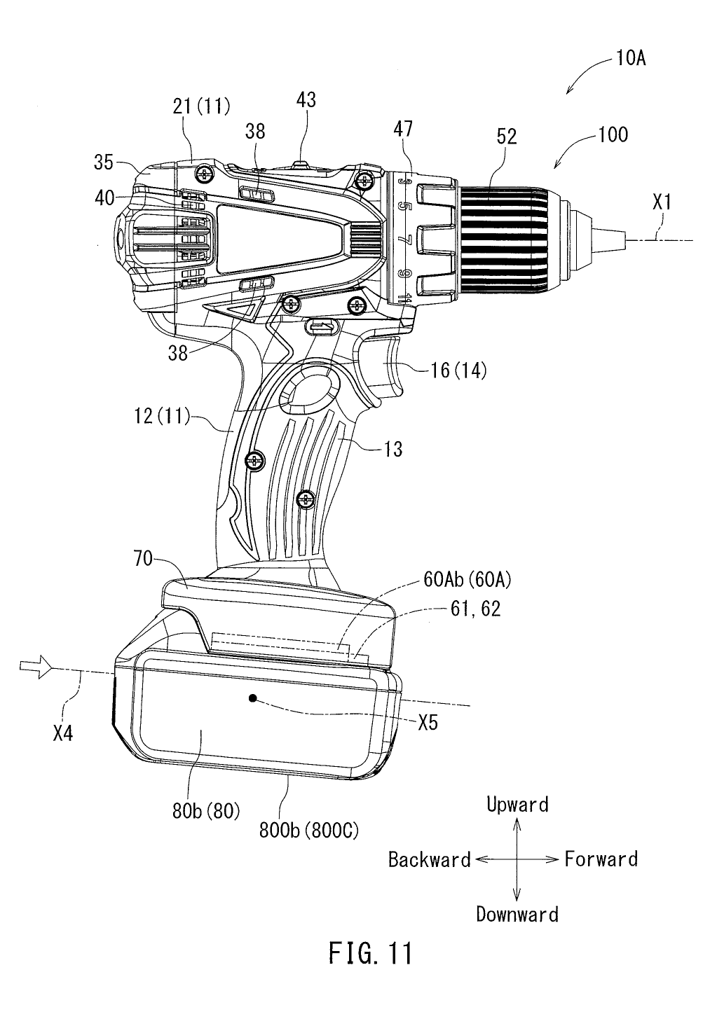

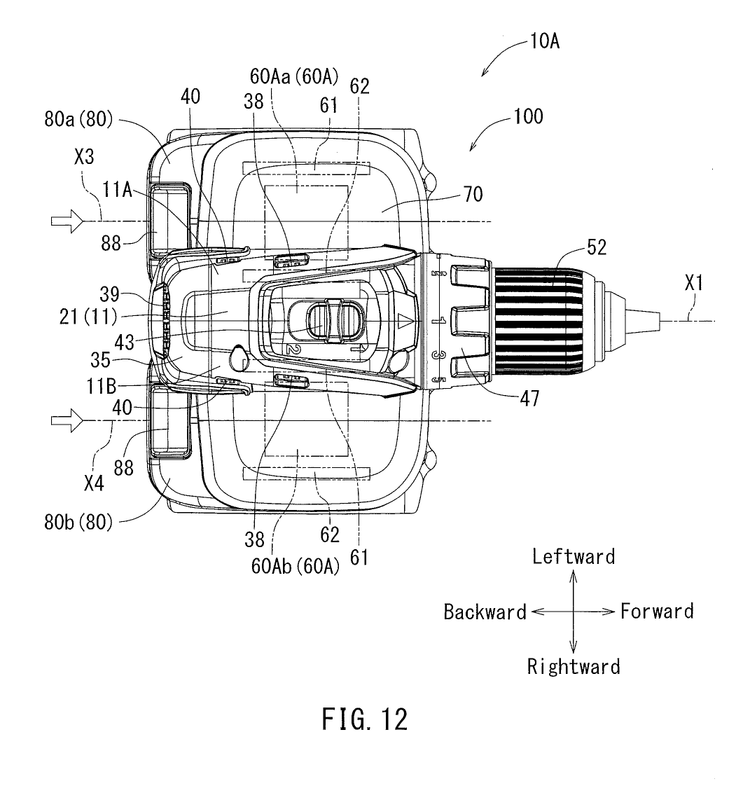

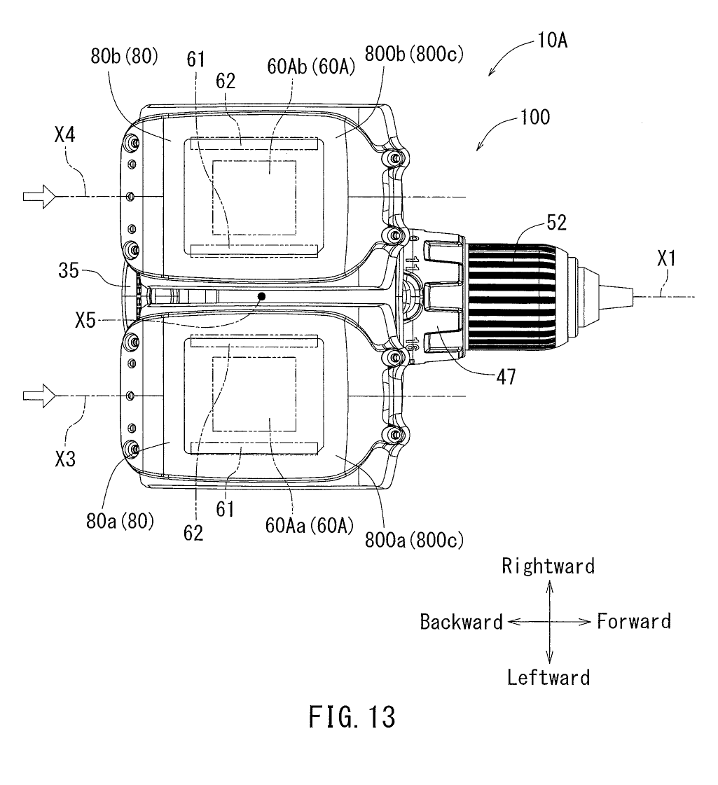

Next, a second embodiment modified from the first embodiment described above will be described with reference to FIGS. 10 to 13. Further, other embodiments including the second embodiment are different from the first embodiment only in the structure of the battery attachment portions 60 of the driver drill 10. Therefore, elements that are the substantially same as the first embodiment will be identified by the same reference numerals used in the first embodiment and a detailed description of such elements may be omitted. In comparison with the driver drill 10 of the first embodiment, in a driver drill 10A of the second embodiment, slide-fitting directions of the rechargeable batteries 80a and 80b may respectively be reversed. That is, both of a first battery attachment portion 60Aa (60A) and a second battery attachment portion 60Ab (60A) of the second embodiment may respectively be directed in directions opposite to the first battery attachment portion 60a (60) and the second battery attachment portion 60b (60) of the first embodiment.

Even in the driver drill 10A of the second embodiment thus constructed, the substantially same effects as the driver drill 10 of the first embodiment may be produced. Further, in the driver drill 10A of the second embodiment, when the user grasps the handle portion 13 by the right hand, the user can visually certain as to whether the rechargeable batteries 80 are attached thereto. Therefore, the driver drill 10A may be easier to use than the driver drill 10 of the first embodiment. To the contrary, in the driver drill 10 of the first embodiment, when the user intends to attach the rechargeable batteries 80 thereto or to detach the same therefrom by the right hand while grasping the handle portion 13 by the left hand, the user can attach the rechargeable batteries 80 thereto or to detach the same therefrom with the hands directed in opposite directions. Therefore, the driver drill 10 may be easier to use.

### Third Embodiment

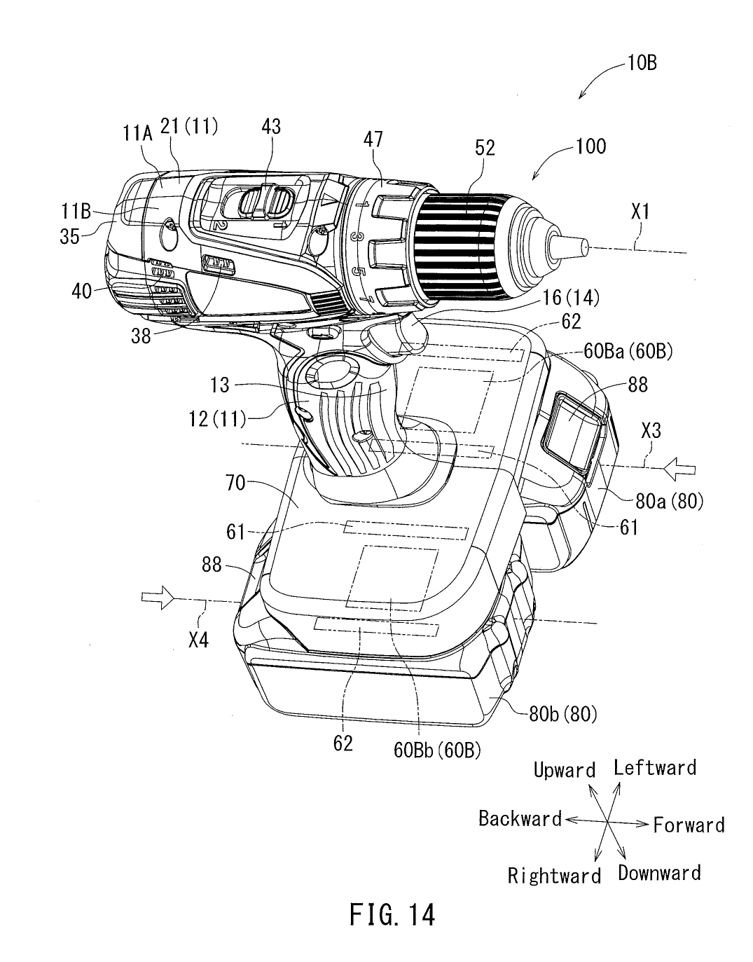

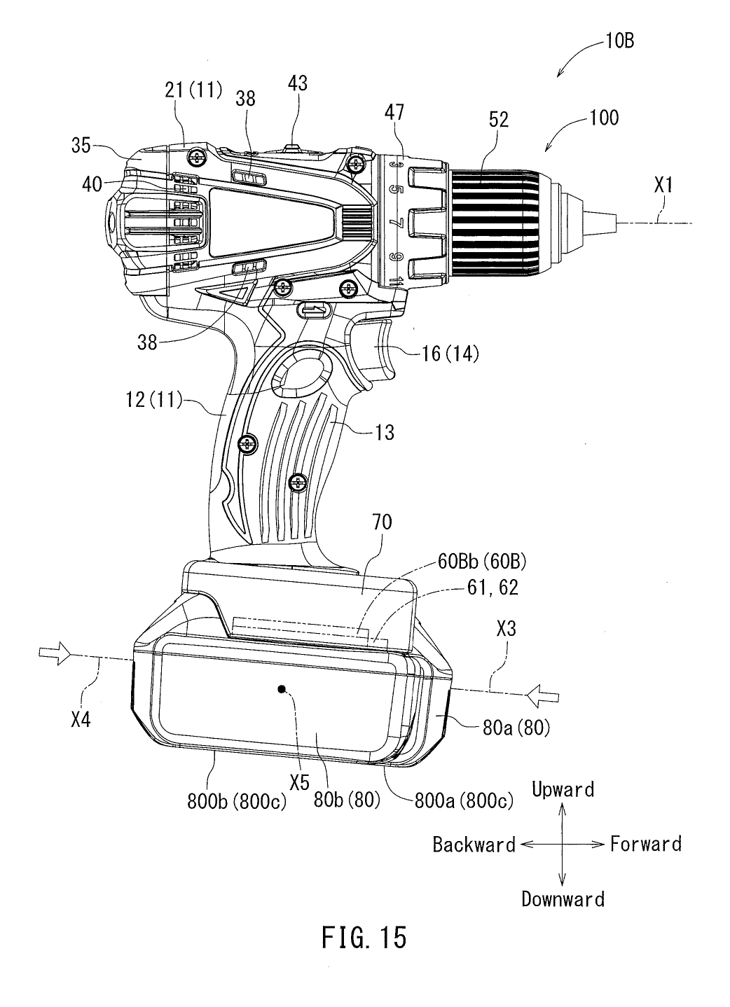

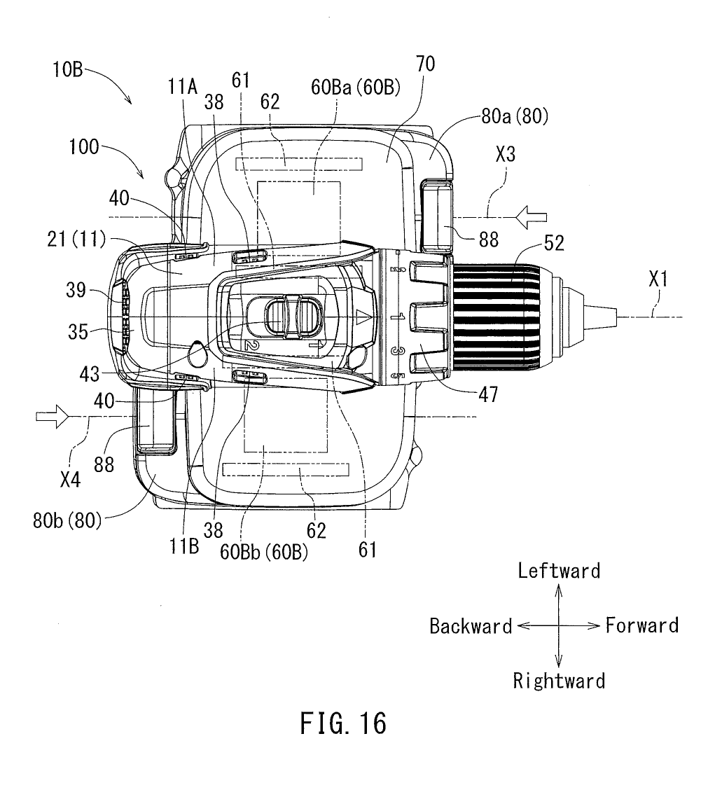

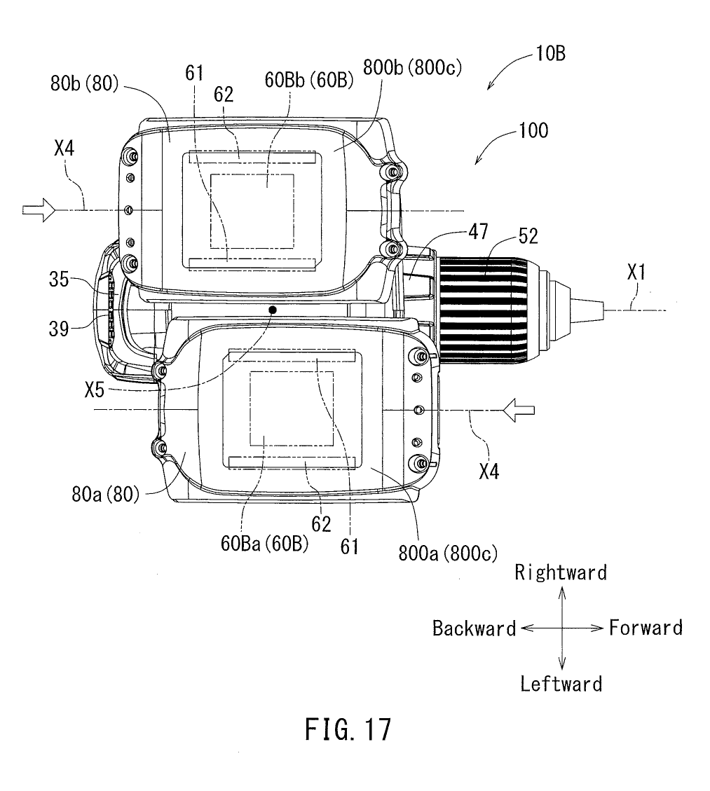

Next, a third embodiment modified from the first embodiment described above will be described with reference to FIGS. 14 to 17. In comparison with the driver drill 10 and 10A of the first and second embodiments, in a driver drill 10B of the second embodiment, one of the slide-fitting directions of the rechargeable batteries 80a and 80b may be reversed. That is, a first battery attachment portion 60Ba (60B) of the third embodiment may have the same structure as the first battery attachment portion 60a (60) of the first embodiment whereas a second battery attachment portion 60Bb (60B) of the third embodiment may have the same structure as the second battery attachment portion 60b (60) of the second embodiment. Even in the driver drill 10B of the third embodiment thus constructed, the substantially same effects as the driver drill 10 of the first embodiment may be produced. Further, in the driver drill 10B of the third embodiment, the fitting directions of the juxtaposed rechargeable batteries 80a and 80b may respectively be directed in opposite directions. Therefore, the user can easily grasp side surfaces of the rechargeable batteries 80. As a result, the rechargeable batteries 80 can be relatively easily attached to or detached from the driver drill 10B.

### Fourth Embodiment

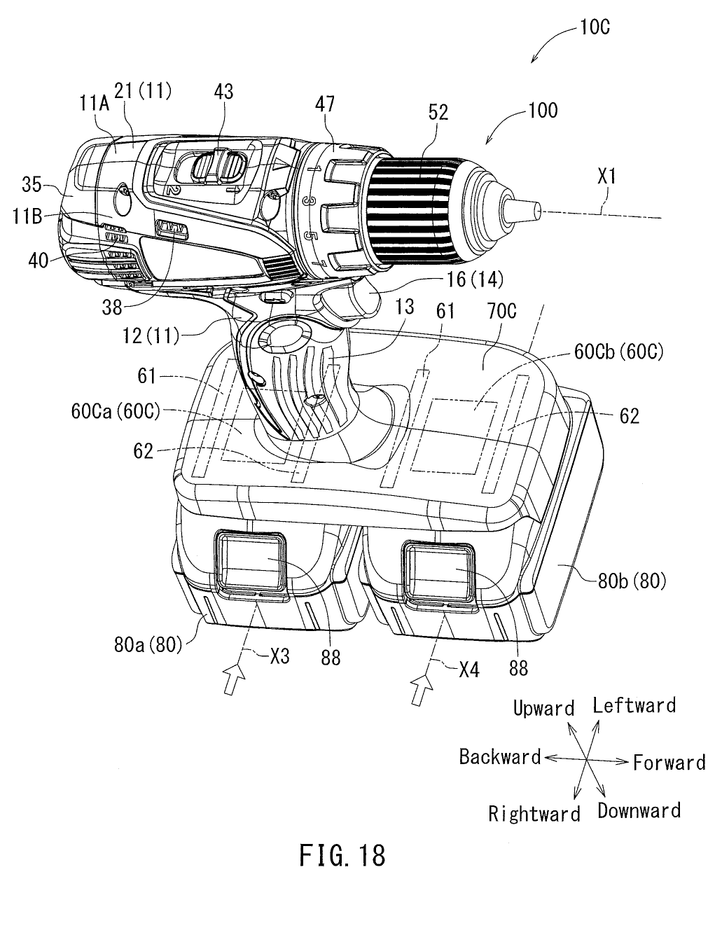

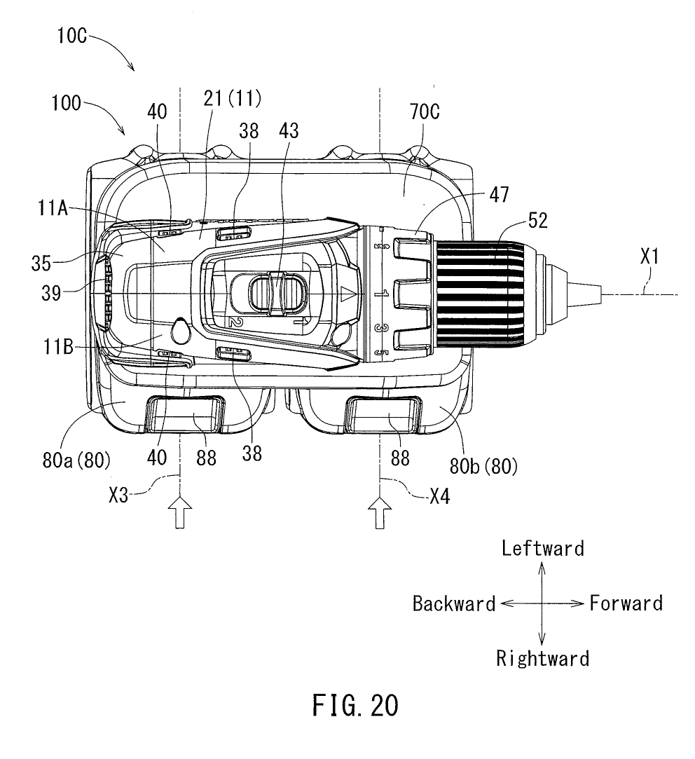

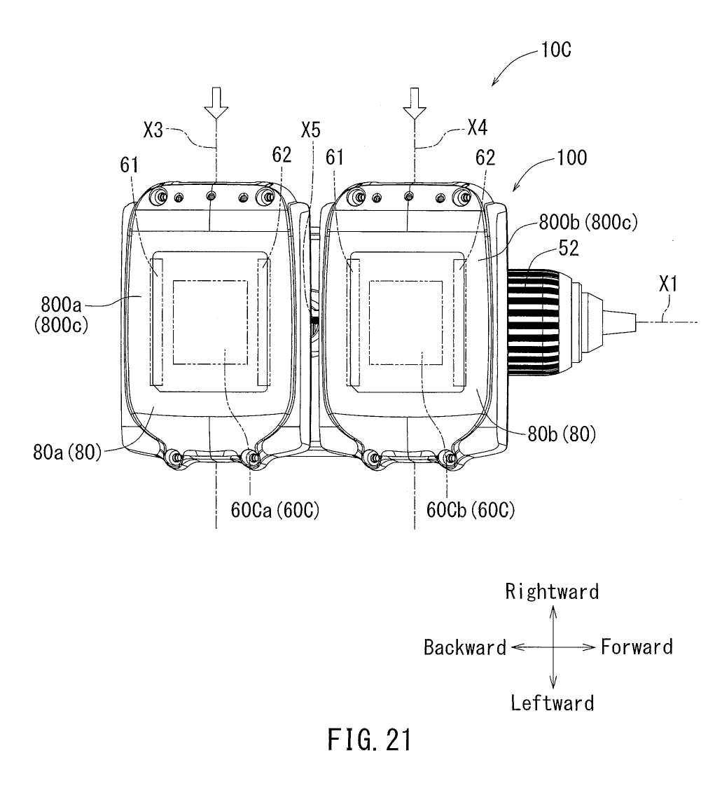

Next, a fourth embodiment modified from the first embodiment described above will be described with reference to FIGS. 18 to 21. In comparison with the driver drill 10 of the first embodiment, in a driver drill 10C of the fourth embodiment, a whole enlarged coupling portion 70C to which a first battery attachment portion 60Ca (60C) and a second battery attachment portion 60Cb (60C) are attached may be rotated clockwise 90 degrees with respect to the grip housing portion 12. Therefore, the first battery attachment portion 60Ca (60C) and the second battery attachment portion 60Cb (60C) of the fourth embodiment may have a juxtapositional relation in which they are longitudinally juxtaposed with respect to the enlarged coupling portion 70C. Therefore, the slide-fitting directions of the rechargeable batteries 80a and 80b may be determined such that both of the rechargeable batteries 80a and 80b are respectively attached to the first and second battery attachment portions 60Ca and 60Cb by sliding the same from right to left.

The first battery attachment portion 60Ca and the second battery attachment portion 60Cb may be juxtaposed in the longitudinal direction in which the motor shaft 26 extends. That is, the first battery attachment portion 60Ca and the second battery attachment portion 60Cb may be positioned such that the slide-fitting directions of the rechargeable batteries 80a and 80b may respectively intersect with the axis line X1 of the motor shaft 26. According to the driver drill 10C, because the first and second battery attachment portions 60Ca and 60Cb are juxtaposed in the longitudinal direction in which the motor shaft 26 extends, volume of the rechargeable batteries 80a and 80b attached to the first and second battery attachment portions 60Ca and 60Cb can be spread in the longitudinal direction. That is, because the motor shaft 26 of the driver drill 10C may extend in the longitudinal direction, the volume of the rechargeable batteries 80a and 80b may be aligned with the direction in which the motor shaft 26 extends. Thus, the volume of the rechargeable batteries 80a and 80b may be elongated in the direction in which the motor shaft 26 of the driver drill 10C extends. Therefore, the driver drill 10C having the rechargeable batteries 80a and 80b can be reduced in size as a whole. As a result, when the driver drill 10C is used to perform the screw tightening operation or other such operations while it is held in hand, good usability of the driver drill 10C can be maintained.

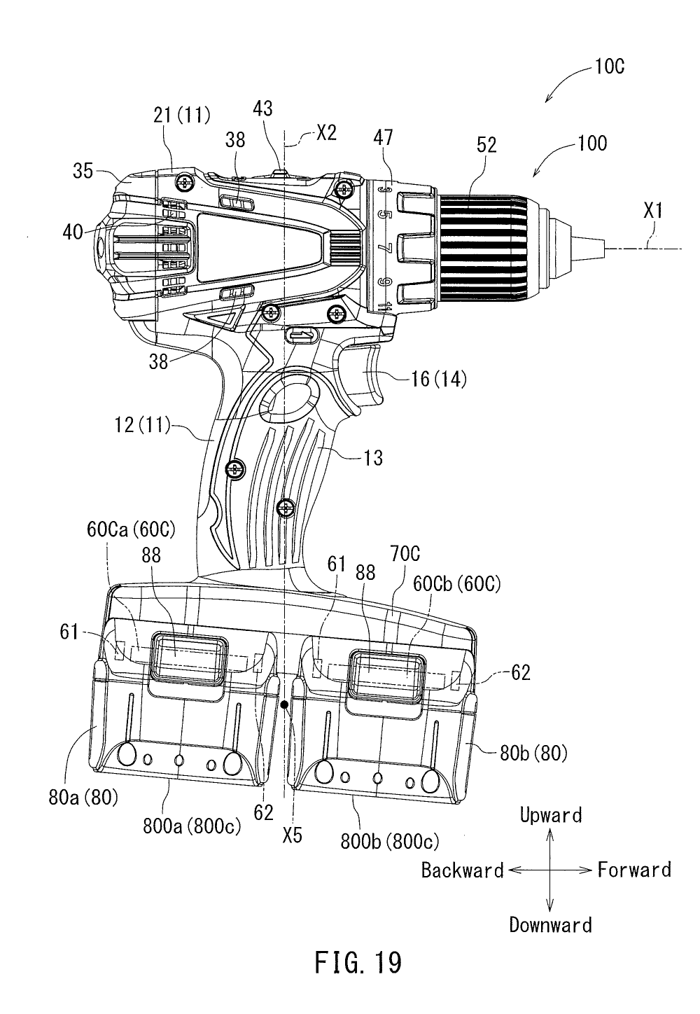

Further, as shown in FIG. 19, the two rechargeable batteries 80a and 80b attached to the first and second battery attachment portions 60Ca and 60Cb may be positioned such that the combined gravity center X5 thereof is positioned on the vertical line X2 through the gravity center of the tool main body 100 in the condition in which the two rechargeable batteries 80a and 80b are detached therefrom. Therefore, even in the condition in which the rechargeable batteries 80a and 80b are attached to the tool main body 100, good usability of the driver drill 10C can not be changed. Further, in the driver drill 10C of the above-described embodiment, the two battery attachment portions 60a and 60b may respectively be positioned such that the lower surfaces 800a and 800b of the two rechargeable batteries 80a and 80b attached to the two battery attachment portions 60a and 60b by slide-fitting may be flush with each other. As a result, the lower surfaces 800a and 800b of the two rechargeable batteries 80a and 80b attached to the battery attachment portions by slide-fitting may form common lower surfaces 800c that are flush with each other. Therefore, when there is a need to temporarily store the driver drill 10C, the driver drill 10C can be stably stored by placing the same on a storage surface with the common lower surfaces 800c facing the storage surface. Further, according to the driver drill 10C, when the user intends to attach the rechargeable batteries 80 thereto or to detach the same therefrom by the right hand while grasping the handle portion 13 by the left hand, the user can attach the rechargeable batteries 80 thereto or to detach the same therefrom with the hands directed in opposite directions. Therefore, the driver drill 10C may be easy to use.

### Fifth Embodiment

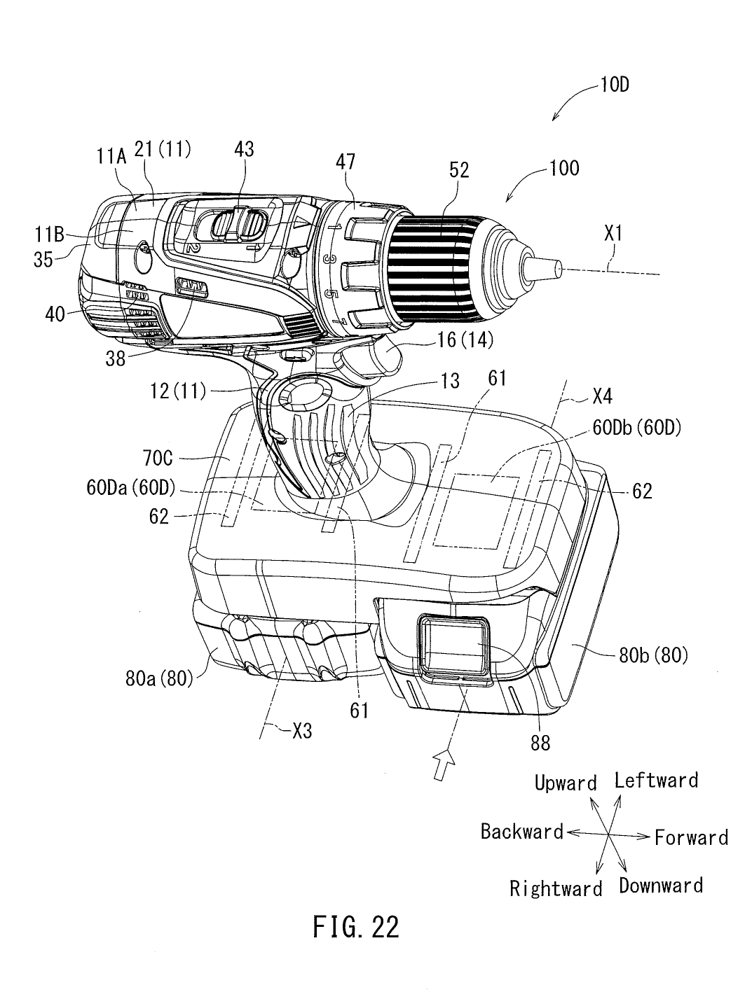

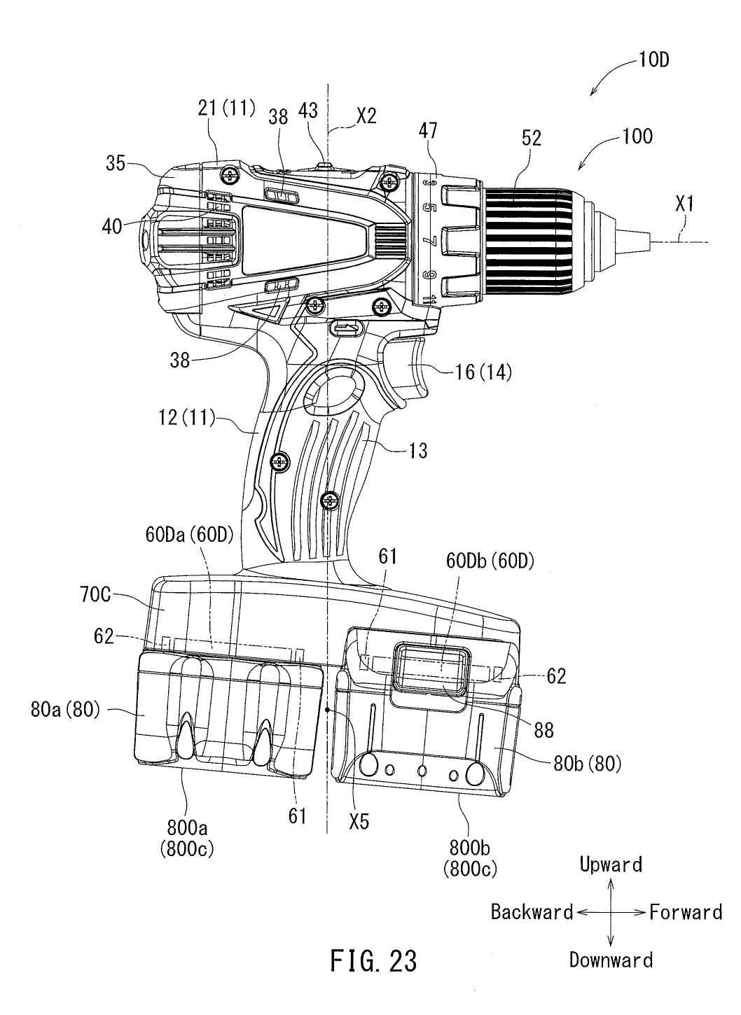

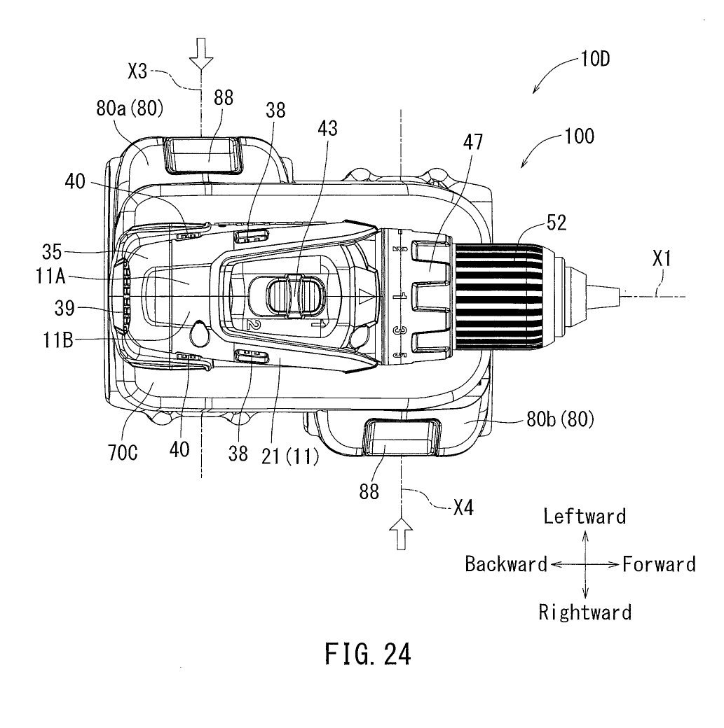

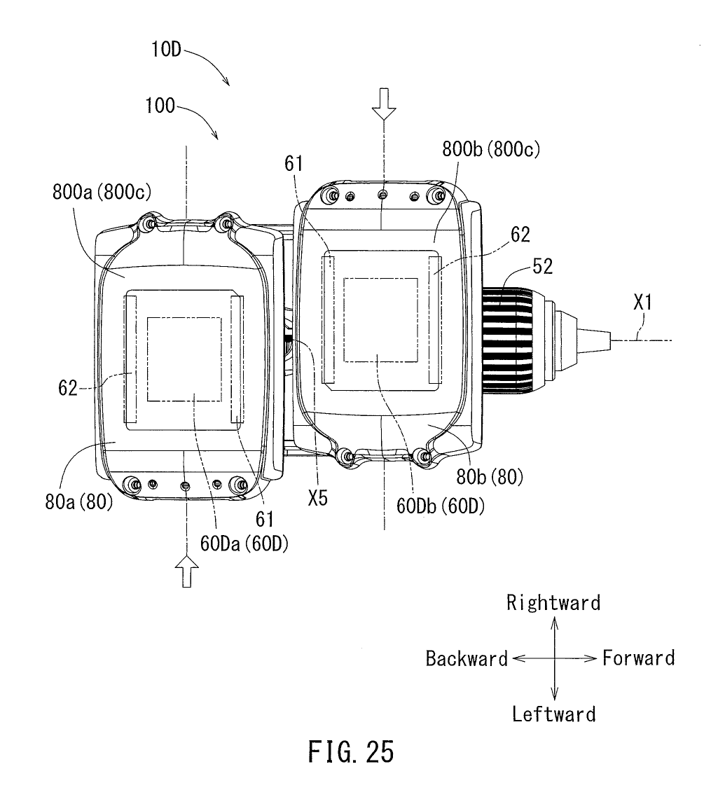

Next, a fifth embodiment modified from the fourth embodiment described above will be described with reference to FIGS. 22 to 25. In comparison with the driver drill 10C of the fourth embodiment described above, in a driver drill 10D of the fifth embodiment, one of the slide-fitting directions of the rechargeable batteries 80a and 80b may be reversed. That is, a second battery attachment portion 60Db (60D) of the fifth embodiment may have the same structure as the second battery attachment portion 60Cb (60C) of the fourth embodiment whereas a first battery attachment portion 60Da (60D) of the fifth embodiment may be directed in a direction opposite to the first battery attachment portion 60Ca (60C) of the fourth embodiment. Even in the driver drill 10D of the fifth embodiment thus constructed, the substantially same effects as the driver drill 10C of the fourth embodiment may be produced. Further, in the driver drill 10D of the fifth embodiment, the fitting directions of the juxtaposed rechargeable batteries 80a and 80b may respectively be directed in opposite directions. As a result, the driver drill 10D can be laterally balanced in weight. Therefore, when the driver drill 10D is used to perform the screw tightening operation or other such operations while it is held in hand, good usability of the driver drill 10D can be maintained due to an excellent lateral balance.

### Sixth Embodiment

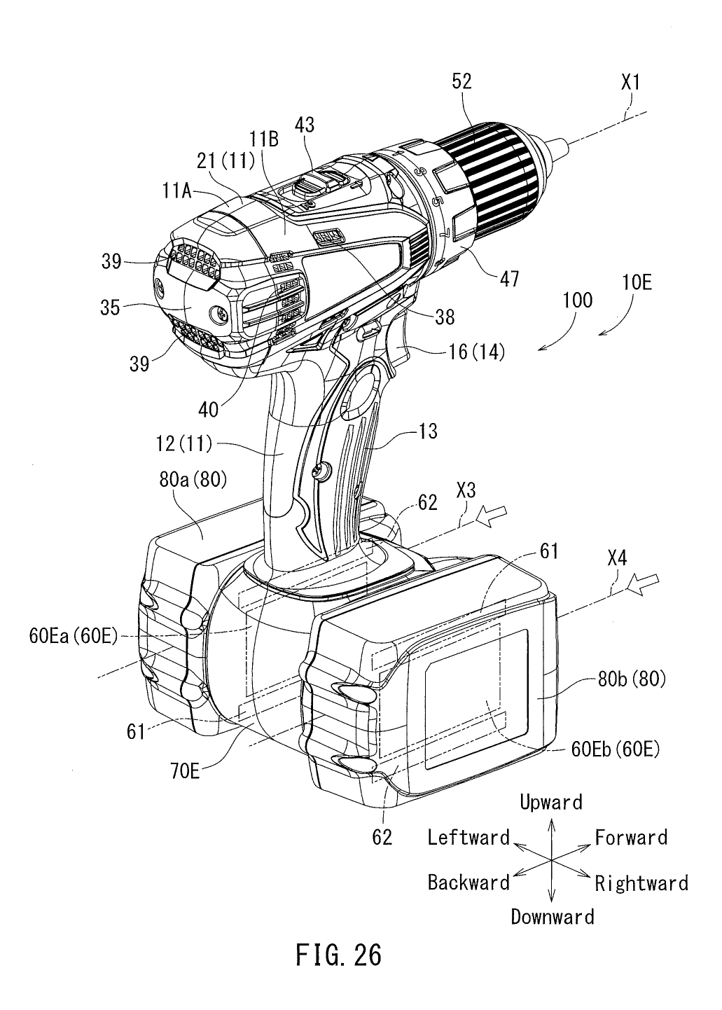

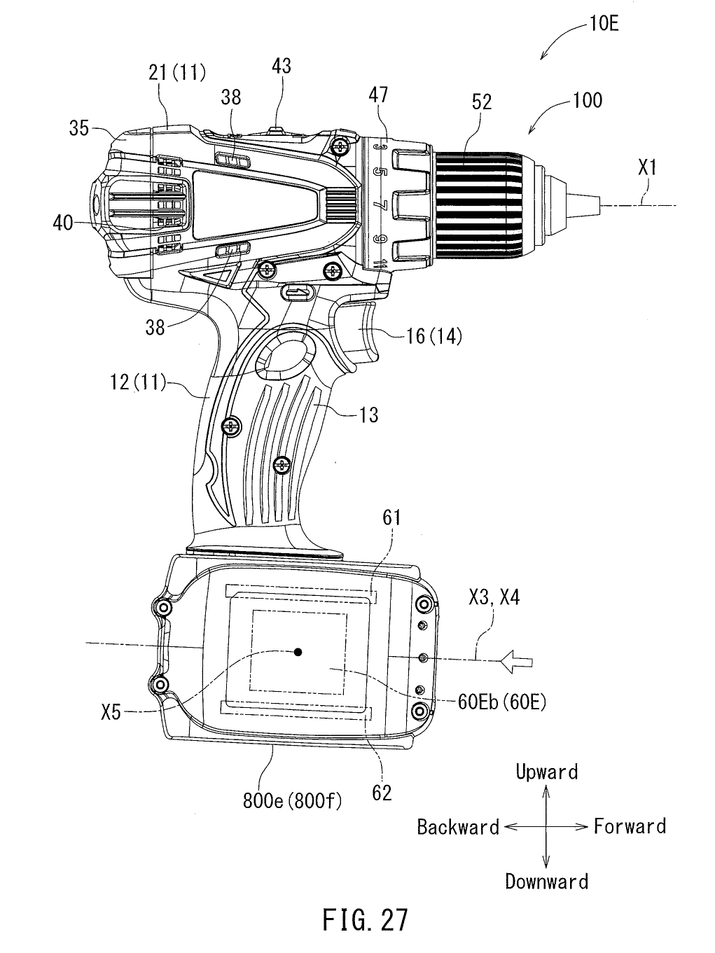

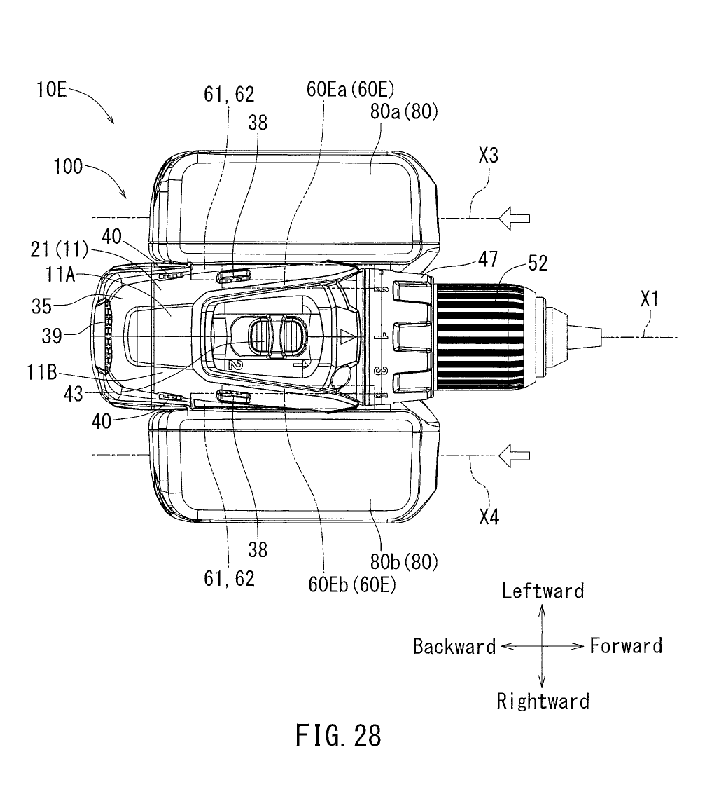

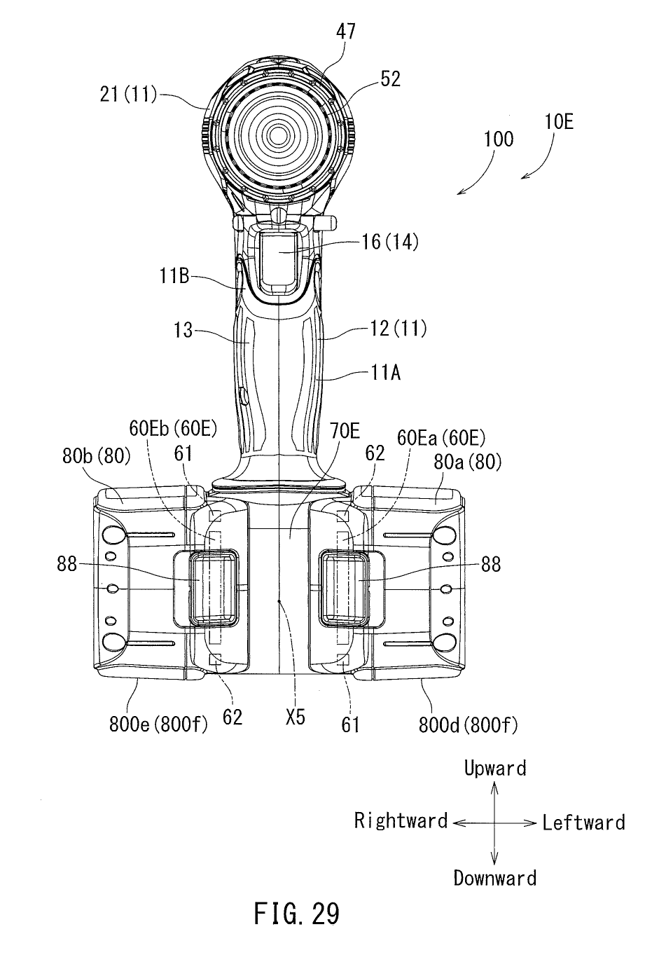

Next, a sixth embodiment different from the first and fourth embodiments described above will be described with reference to FIGS. 26 to 29. Unlike the driver drill 10 of the first embodiment described above, in a driver drill 10E of the sixth embodiment, the rechargeable batteries 80a and 80b may be attached to battery attachment portions 60Ea and 60Eb by sliding the same from before backward while they are laterally faced. In particular, a first battery attachment portion 60Ea (60E) and a second battery attachment portion 60Eb (60E) of the sixth embodiment may have a juxtapositional relation in which they are laterally juxtaposed with respect to an enlarged coupling portion 70E. That is, the first battery attachment portion 60Ea and the second battery attachment portion 60Eb may be laterally positioned symmetrically with respect to the axis X1 of the motor shaft 26. In other words, the first battery attachment portion 60Ea and the second battery attachment portion 60Eb may be positioned such that the enlarged coupling portion 70E of the grip housing portion 12 may be placed between the connecting terminal formation surfaces of the rechargeable batteries 80a and 80b. The first and second battery attachment portions 60Ea and 60Eb may be formed in opposing lateral sides of the enlarged coupling portion. Therefore, the rechargeable batteries 80a and 80b attached to the first and second battery attachment portions 60Ea and 60Eb by slide-fitting may be laterally faced.

The slide-fitting directions of the rechargeable batteries 80a and 80b may be determined such that both of the rechargeable batteries 80a and 80b are respectively attached to the first and second battery attachment portions 60Ea and 60Eb by sliding the same from before backward. According to the driver drill 10E, the substantially same effects as the driver drill 10 of the first embodiment may be produced. Further, in the driver drill 10E, the two battery attachment portions 60a and 60b may respectively be positioned such that side surfaces 800d and 800e of the two rechargeable batteries 80a and 80b attached to the two battery attachment portions 60a and 60b by slide-fitting may be flush with each other. As a result, the lower surfaces 800d and 800e of the two rechargeable batteries 80a and 80b attached to the battery attachment portions by slide-fitting may form common lower surfaces 800f that are flush with each other. Therefore, when there is a need to temporarily store the driver drill 10E, the driver drill 10E can be stably stored by placing the same on a storage surface with the common lower surfaces 800f facing the storage surface. Further, according to the driver drill 10E, when the user intends to attach the rechargeable batteries 80 thereto or to detach the same therefrom by the right hand while grasping the handle portion 13 by the left hand, the user can attach the rechargeable batteries 80 thereto or to detach the same therefrom with the hands directed in opposite directions. Therefore, the driver drill 10E may be easy to use.

### Seventh Embodiment

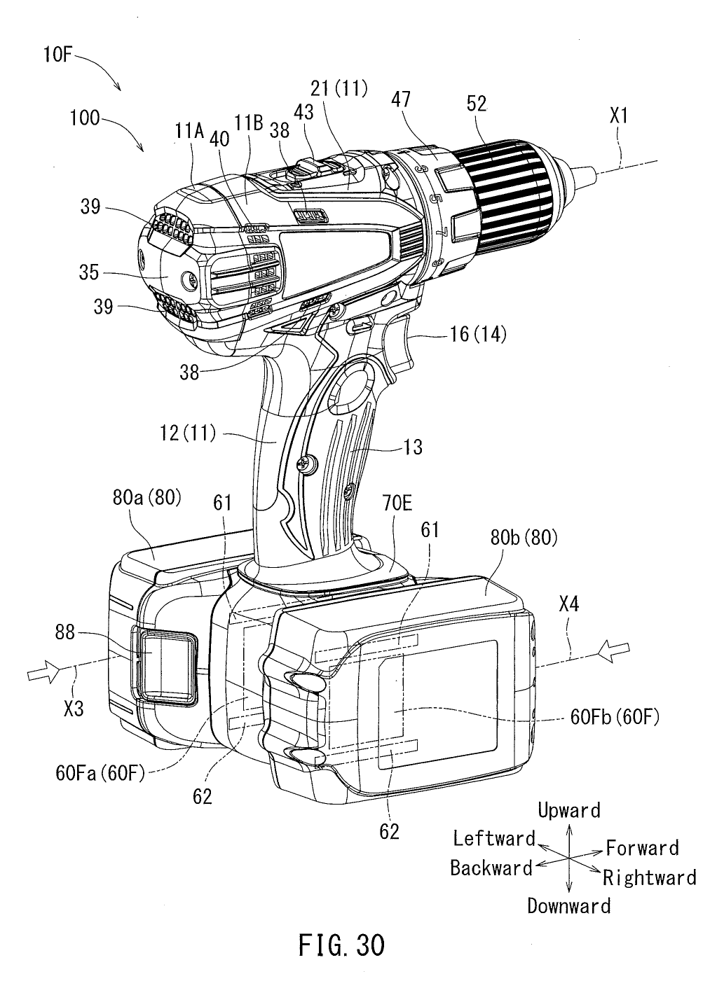

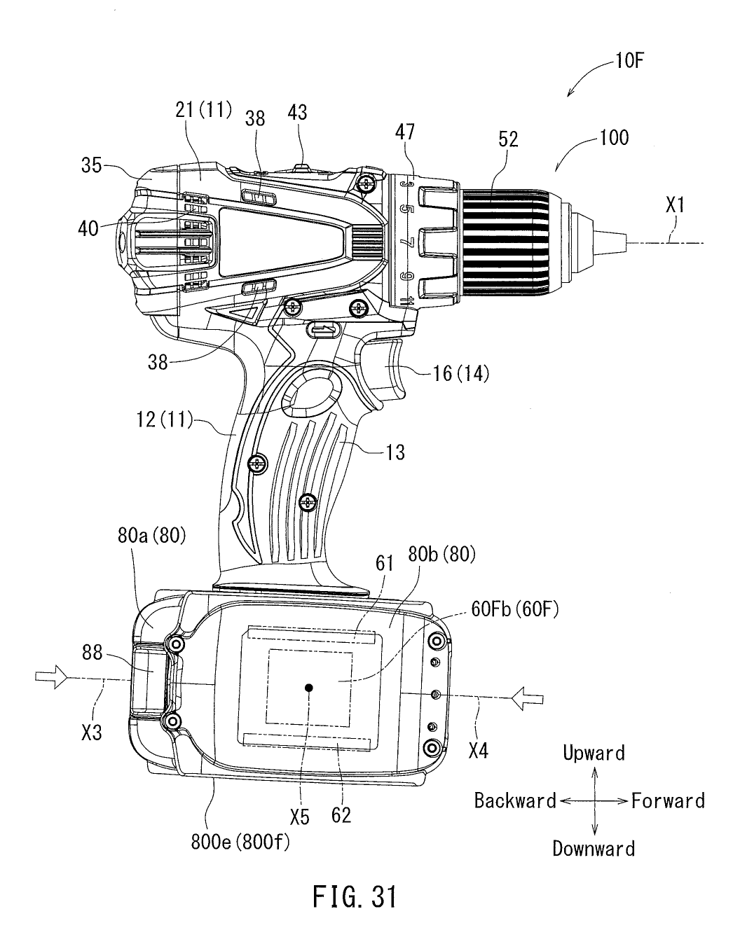

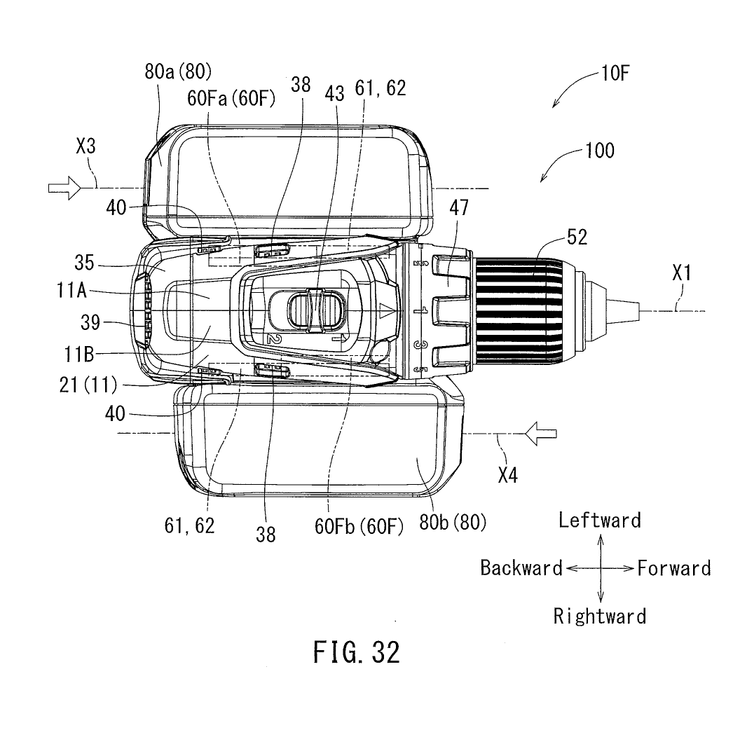

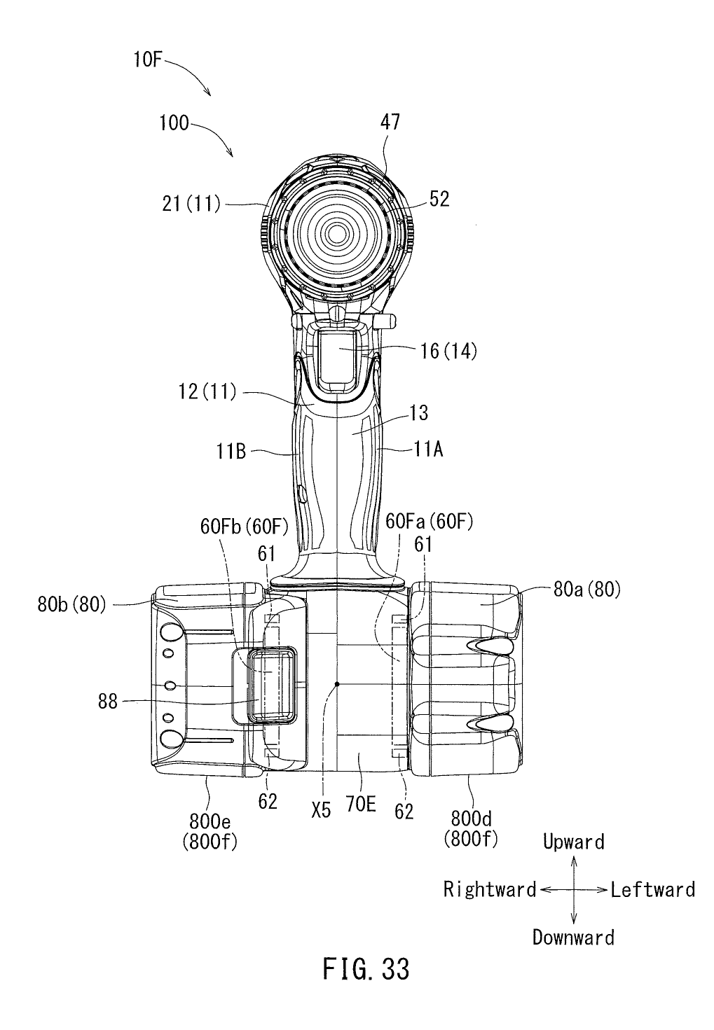

Next, a seventh embodiment modified from the sixth embodiment described above will be described with reference to FIGS. 30 to 33. In comparison with the driver drill 10E of the sixth embodiment described above, in a driver drill 10F of the seventh embodiment, one of the slide-fitting directions of the rechargeable batteries 80a and 80b may be reversed. That is, a first battery attachment portion 60Fa (60F) of the seventh embodiment may be directed in a direction opposite to the first battery attachment portion 60Ea (60E) of the sixth embodiment whereas a second battery attachment portion 60Fb (60F) of the seventh embodiment may have the same structure as the second battery attachment portion 60Eb (60E) of the sixth embodiment. Even in the driver drill 10F of the seventh embodiment thus constructed, the substantially same effects as the driver drill 10E of the sixth embodiment may be produced. However, in the driver drill 10F of the seventh embodiment, the fitting directions of the juxtaposed rechargeable batteries 80a and 80b may be directed in opposite directions. As a result, the lower surfaces 800d and 800e may be longitudinally displaced relative to each other, so that the common lower surfaces 800f can be displaced accordingly. Therefore, the driver drill 10F can be further stably stored.

### Eighth Embodiment

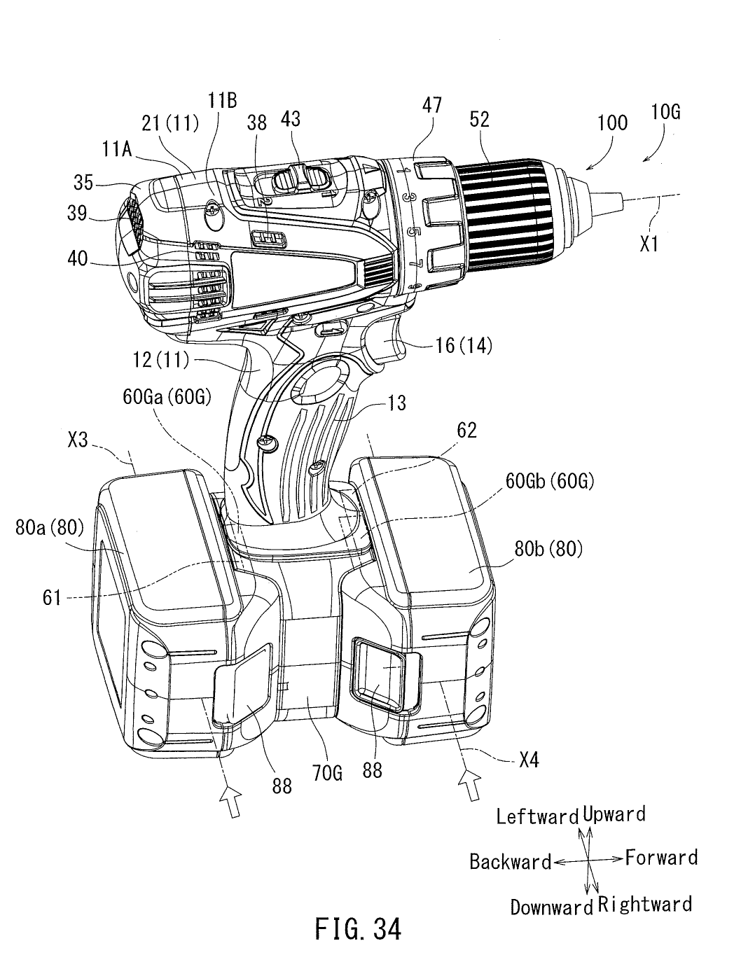

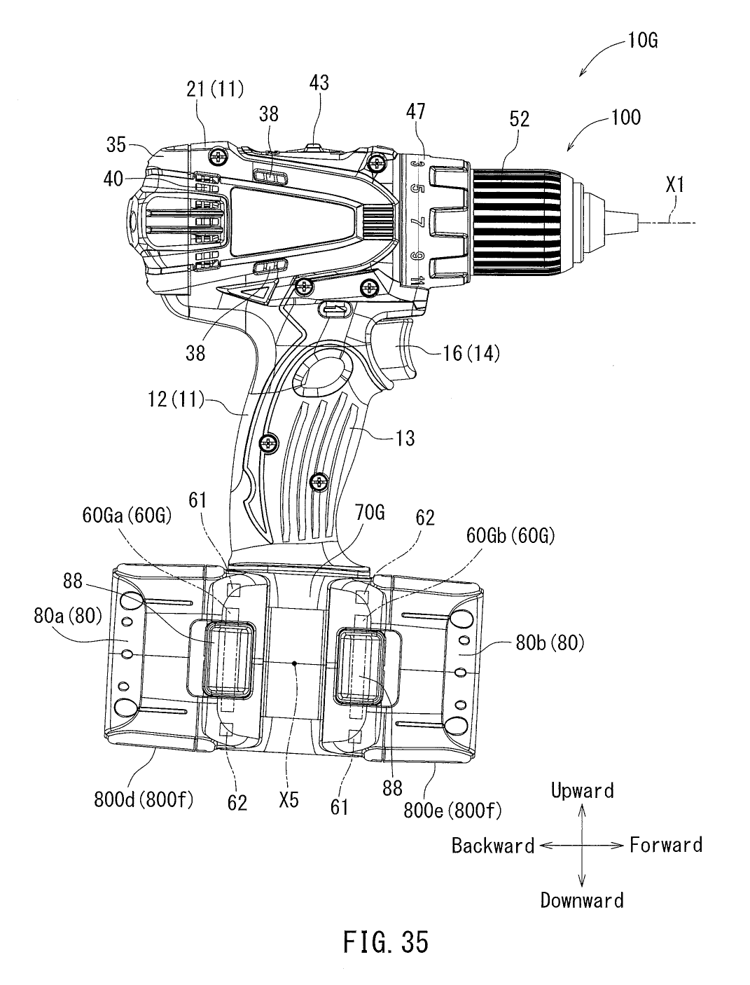

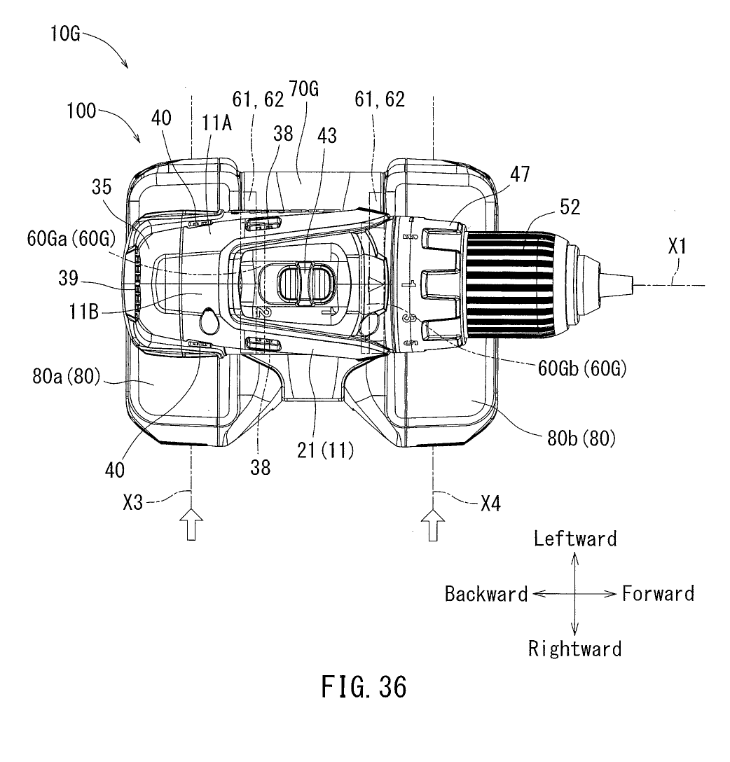

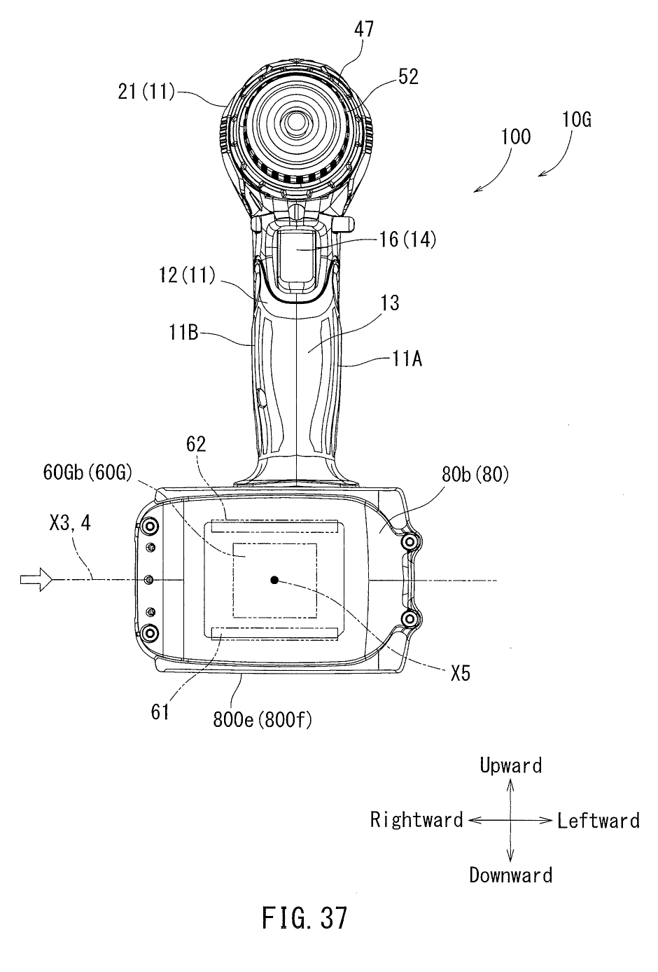

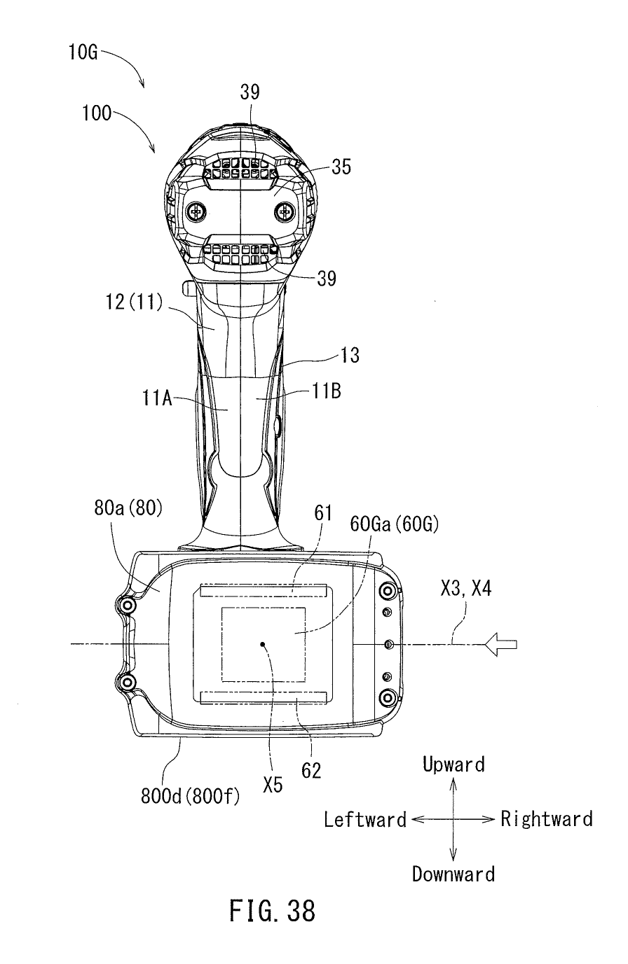

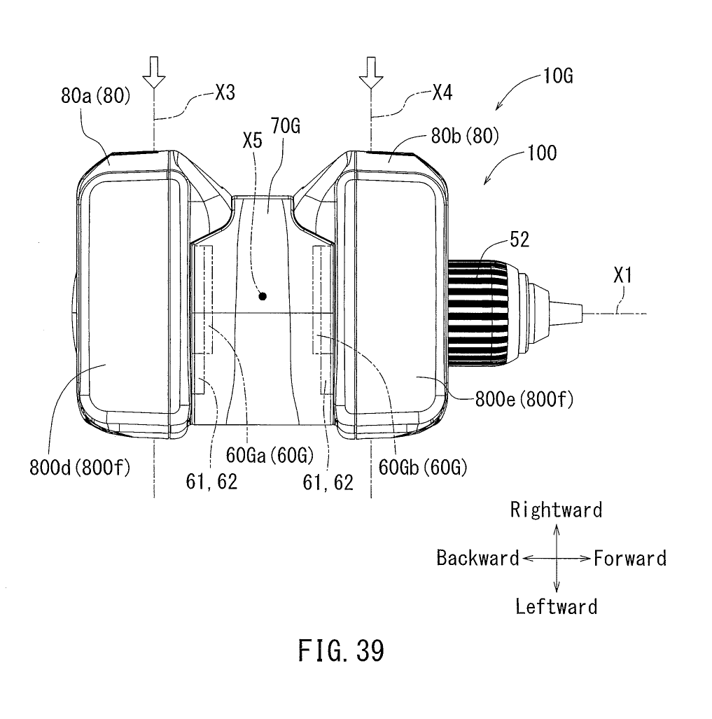

Next, an eighth embodiment modified from the sixth embodiment described above will be described with reference to FIGS. 34 to 39. In comparison with the driver drill 10E of the sixth embodiment described above, in a driver drill 10G of the eighth embodiment, a whole enlarged coupling portion 70G to which a first battery attachment portion 60Ga (60G) and a second battery attachment portion 60Gb (60G) are attached may be rotated clockwise 90 degrees with respect to the grip housing portion 12. Therefore, the first battery attachment portion 60Ga (60G) and the second battery attachment portion 60Gb (60G) of the eighth embodiment may have a juxtapositional relation in which they are longitudinally juxtaposed with respect to the enlarged coupling portion 70G. Therefore, the slide-fitting directions of the rechargeable batteries 80a and 80b may be determined such that both of the rechargeable batteries 80a and 80b are respectively attached to the first and second battery attachment portions 60Ga and 60Gb by sliding the same from right to left. The first battery attachment portion 60Ga and the second battery attachment portion 60Gb may be juxtaposed in the longitudinal direction in which the motor shaft 26 extends. That is, the first battery attachment portion 60Ga and the second battery attachment portion 60Gb may be positioned such that the slide-fitting directions of the rechargeable batteries 80a and 80b may respectively intersect with the axis line X1 of the motor shaft 26.

According to the driver drill 10G, because the first and second battery attachment portions 60Ga and 60Gb are juxtaposed in the longitudinal direction in which the motor shaft 26 extends, the volume of the rechargeable batteries 80a and 80b attached to the first and second battery attachment portions 60Ga and 60Gb can be longitudinally spread. That is, because the motor shaft 26 of the driver drill 10G may extend in the longitudinal direction, the volume of the rechargeable batteries 80a and 80b may be aligned with the direction in which the motor shaft 26 extends. Thus, the volume of the rechargeable batteries 80a and 80b may be elongated in the direction in which the motor shaft 26 of the driver drill 10G extends. Therefore, the driver drill 10G having the rechargeable batteries 80a and 80b can be reduced in size as a whole. As a result, when the driver drill 10G is used to perform the screw tightening operation or other such operations while it is held in hand, good usability of the driver drill 10G can be maintained. Therefore, in the driver drill 10G, effects resulting from a combination of the driver drill 10C of the fourth embodiment describe above and the driver drill 10E of the sixth embodiment described above may be produced.

### Ninth Embodiment

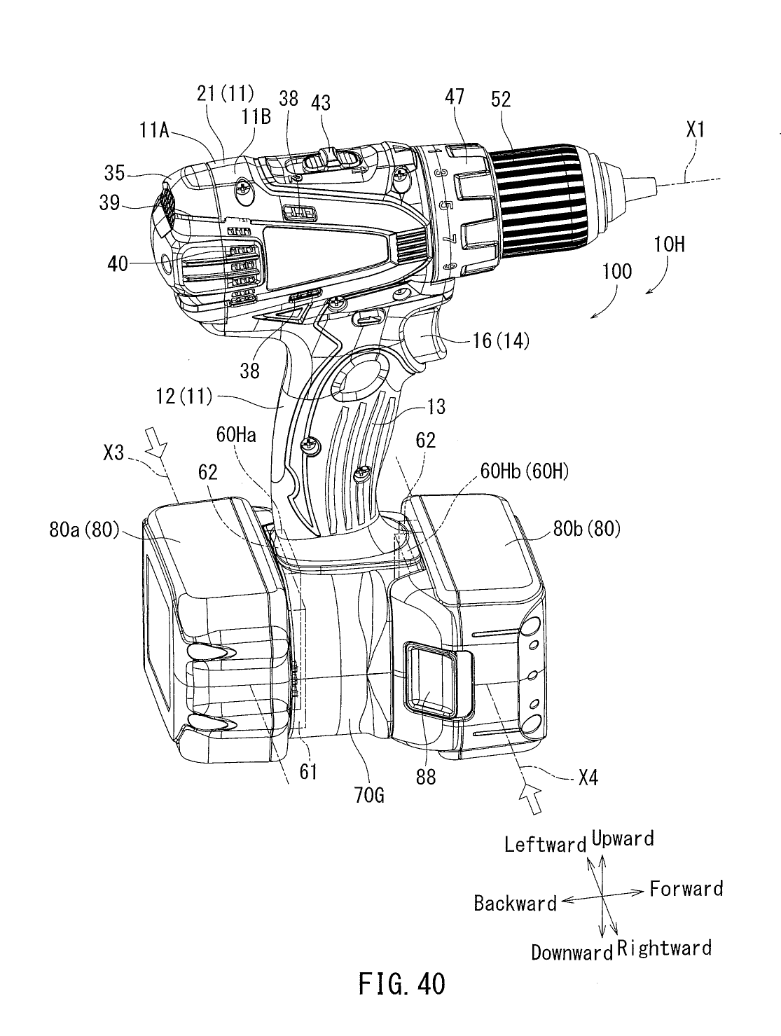

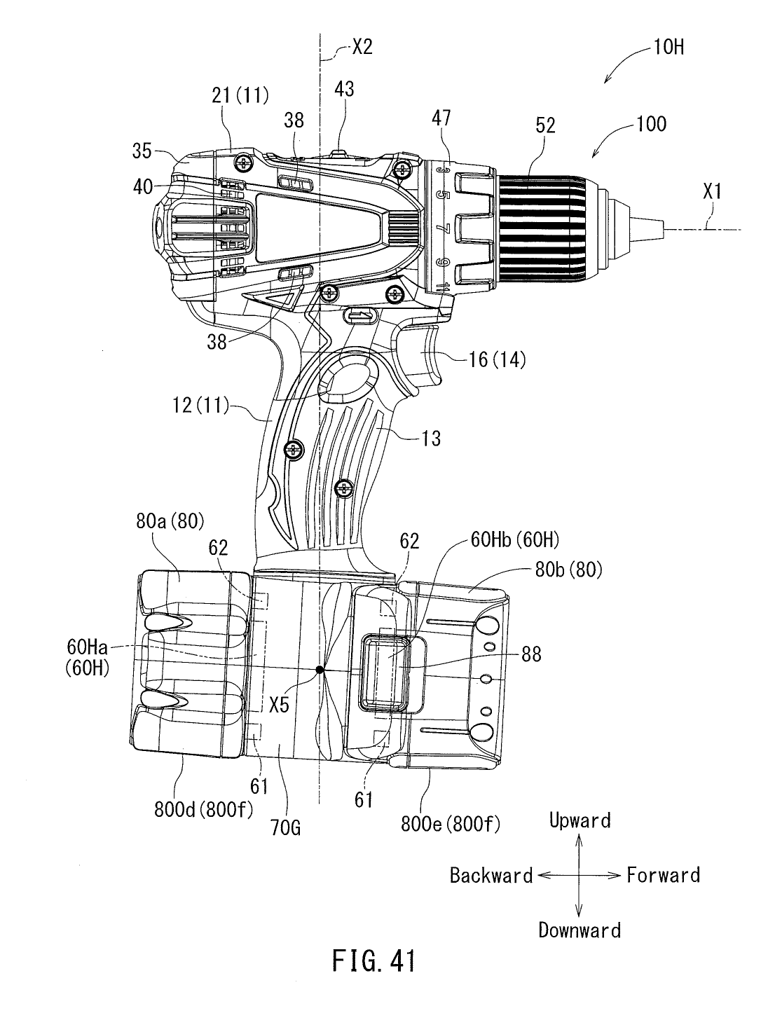

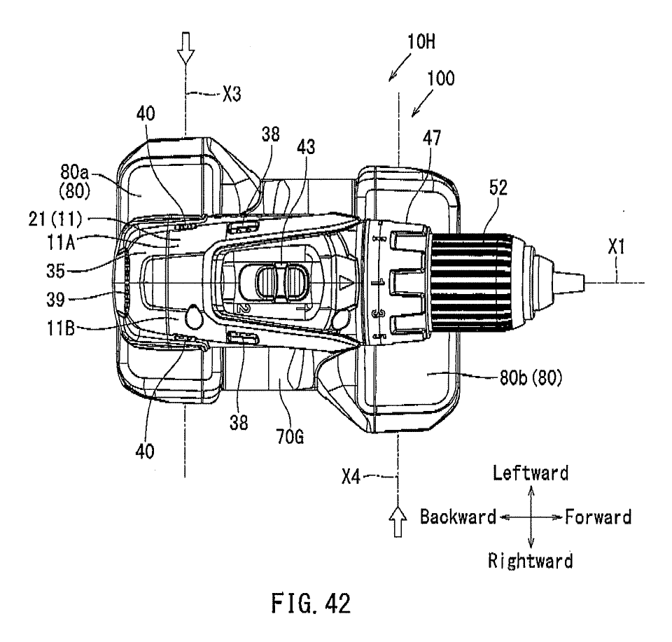

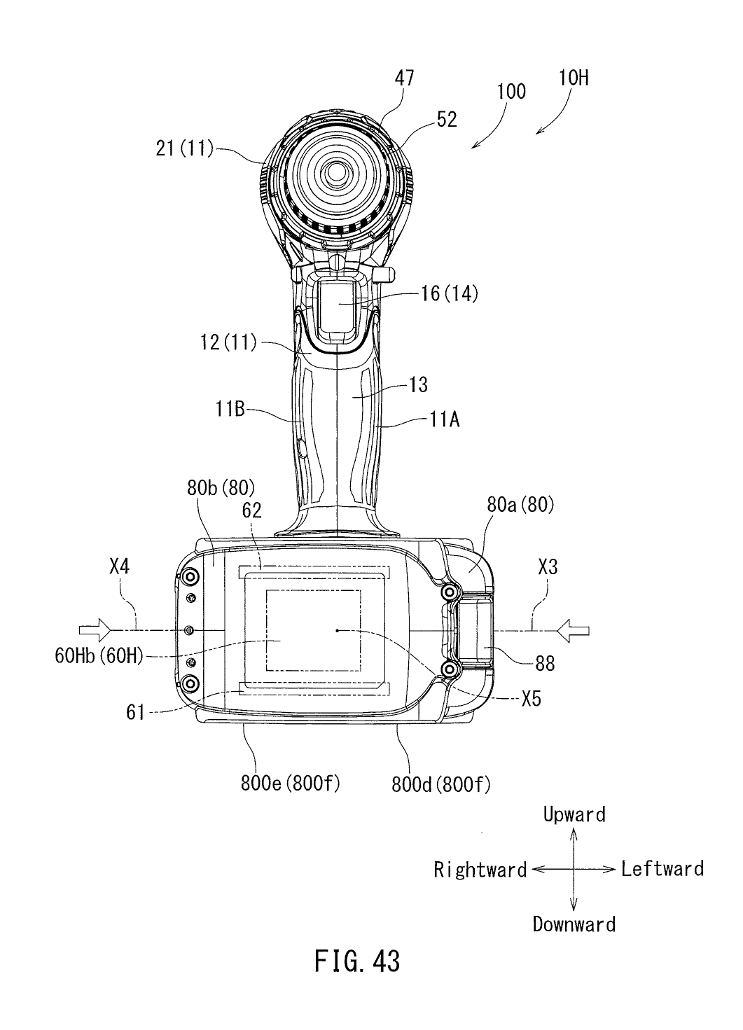

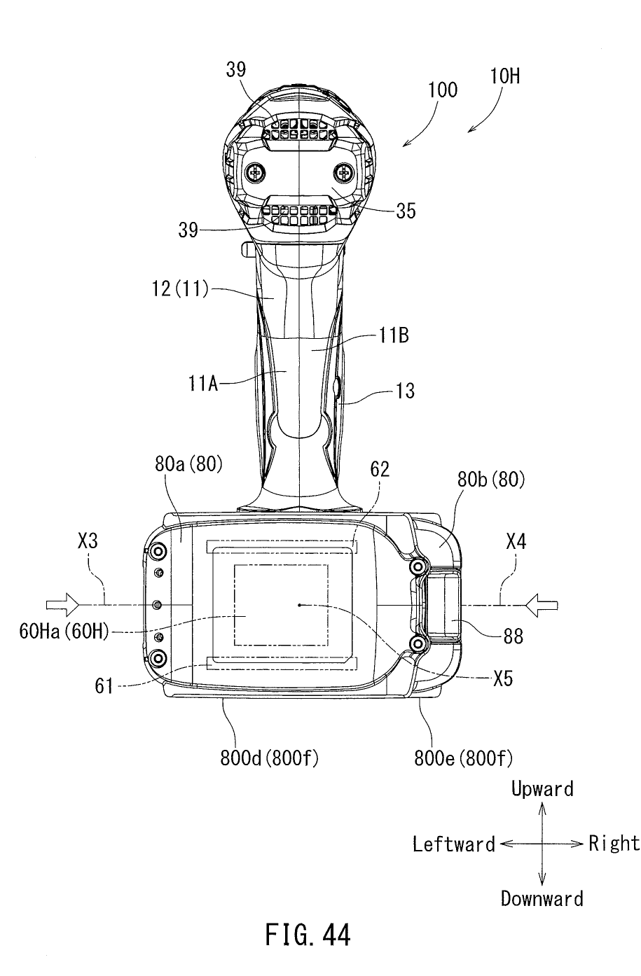

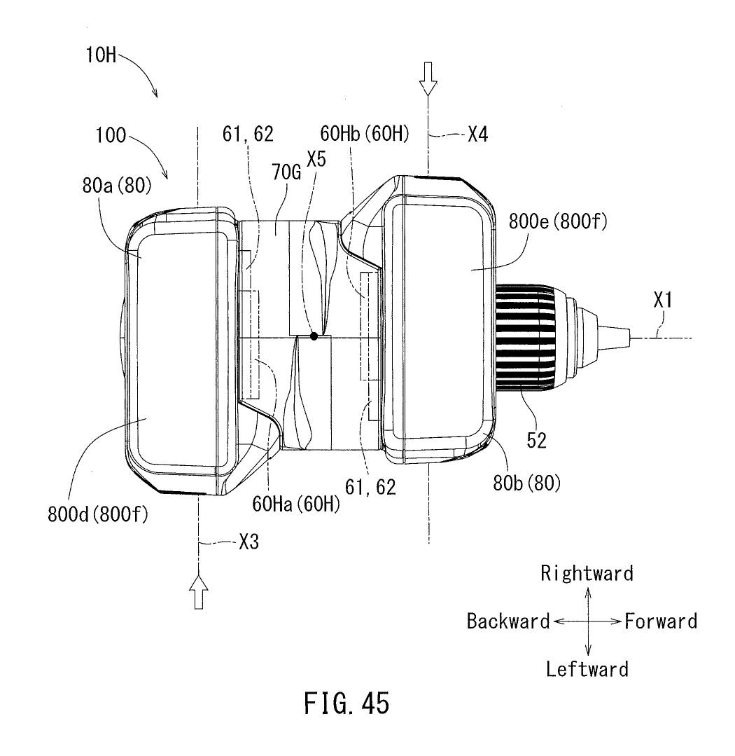

Next, a ninth embodiment modified from the eighth embodiment described above will be described with reference to FIGS. 40 to 45. In comparison with the driver drill 10G of the eight embodiment described above, in a driver drill 10H of the ninth embodiment, one of the slide-fitting directions of the rechargeable batteries 80a and 80b may be reversed. That is, a first battery attachment portion 60Ha (60H) of the ninth embodiment may be directed in a direction opposite to the first battery attachment portion 60Ga (60G) of the eighth embodiment whereas a second battery attachment portion 60Hb (60H) of the ninth embodiment may have the same structure as the second battery attachment portion 60Gb (60G) of the eighth embodiment. Even in the driver drill 10H of the ninth embodiment thus constructed, the substantially same effects as the driver drill 10G of the eighth embodiment may be produced. However, in the driver drill 10H of the ninth embodiment, the fitting directions of the juxtaposed rechargeable batteries 80a and 80b may be directed in opposite directions. As a result, the driver drill 10H can be laterally balanced in weight. Therefore, when the driver drill 10H is used to perform the screw tightening operation or other such operations while it is held in hand, good usability of the driver drill 10H can be maintained due to an excellent lateral balance. Further, the lower surfaces 800d and 800e may be laterally displaced relative to each other, so that the common lower surfaces 800f can be displaced accordingly. Therefore, the driver drill 10H can be further stably stored.

### Tenth Embodiment

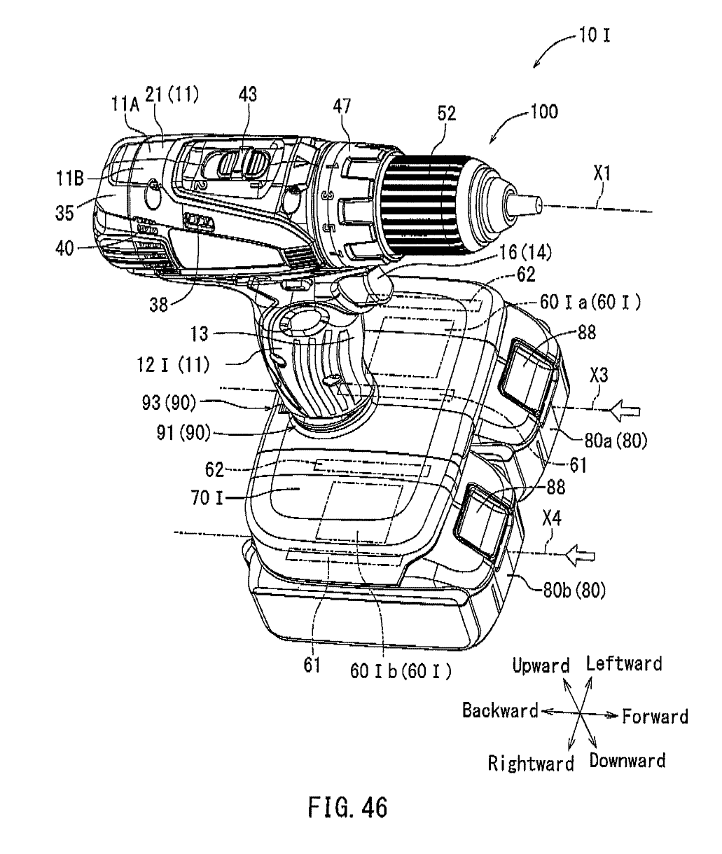

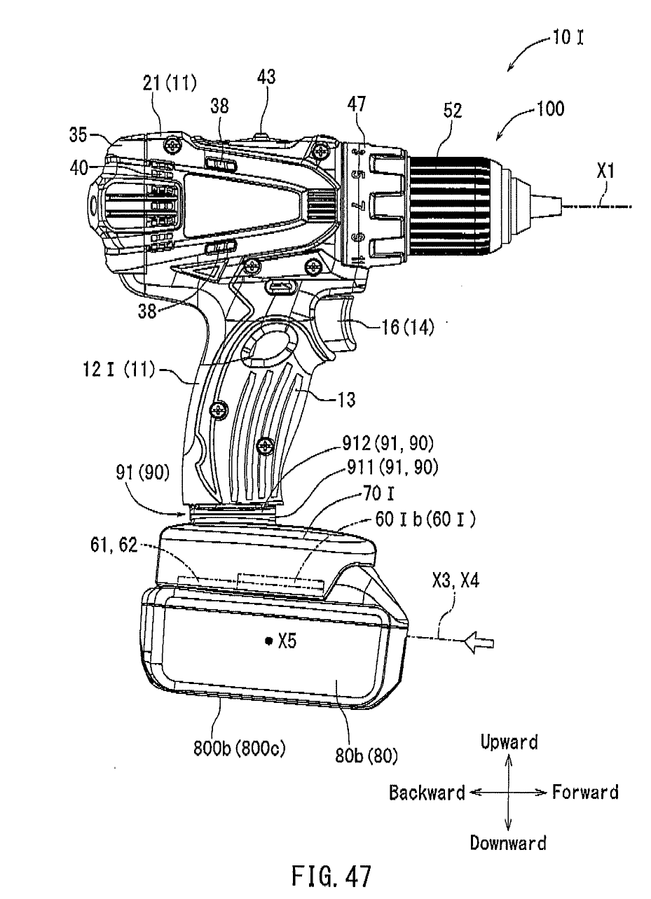

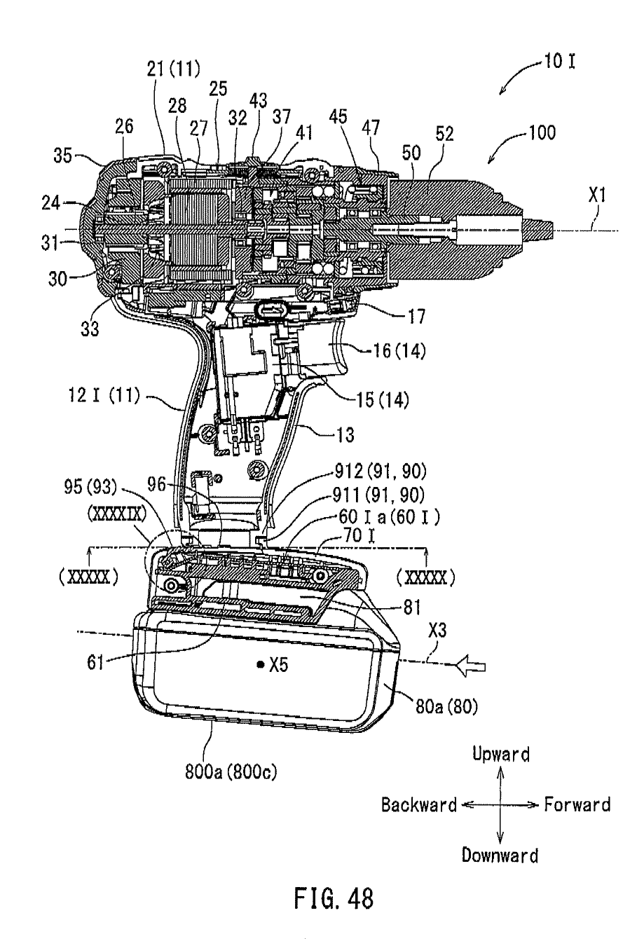

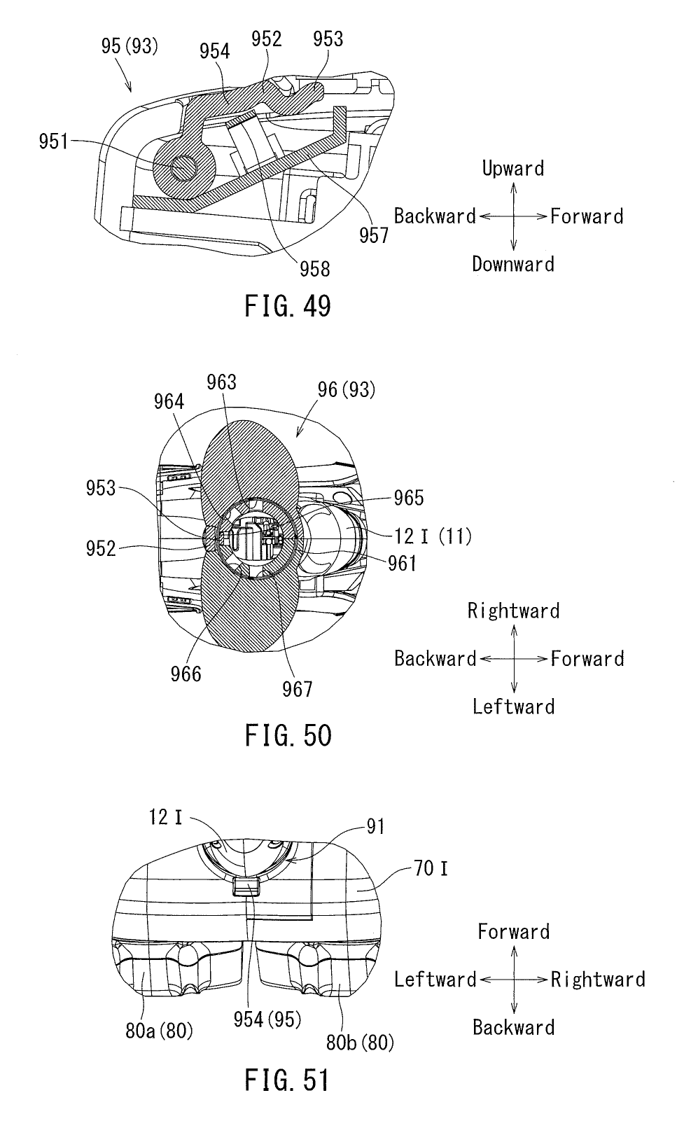

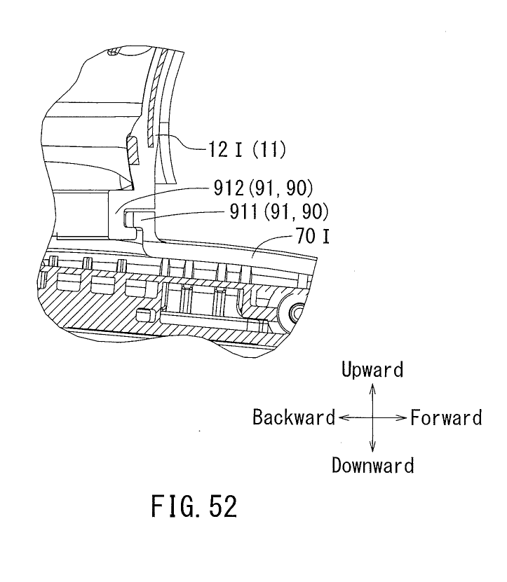

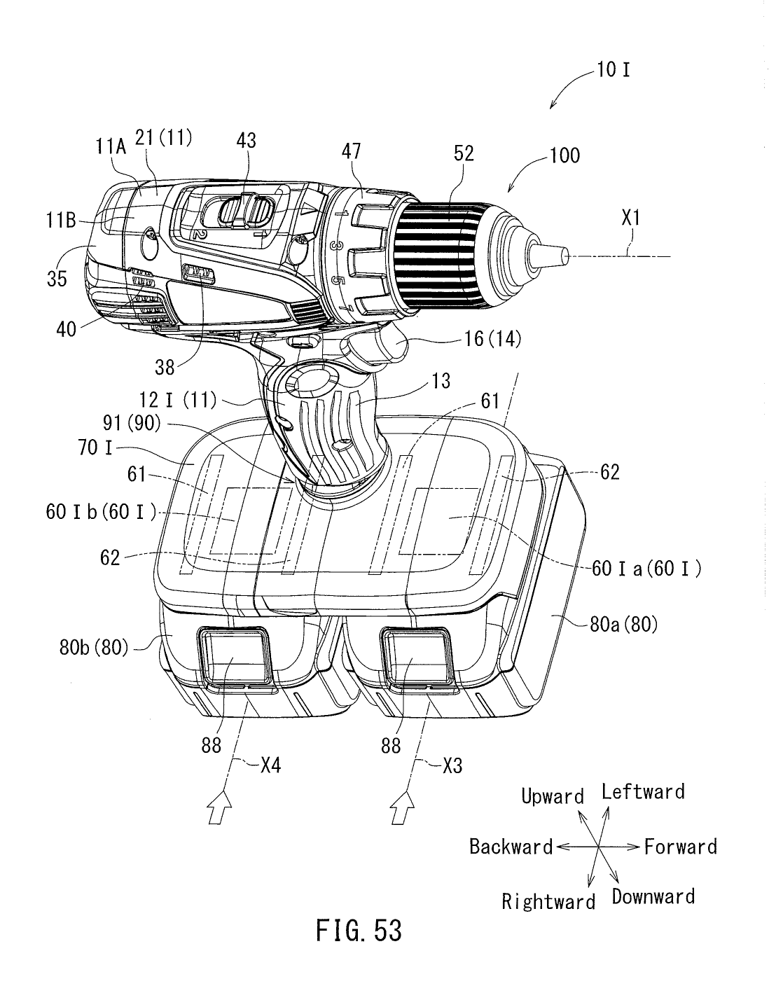

Next, a tenth embodiment modified from the first embodiment described above will be described with reference to FIGS. 46 to 53. Further, FIG. 46 is a perspective view of a driver drill 10I of the tenth embodiment, which view shows an external appearance thereof. FIG. 47 is a side view of the driver drill 10I shown in FIG. 46. FIG. 48 is a vertical sectional view of the driver drill 10I shown in FIG. 46, which view shows a halved internal structure. FIG. 49 is an enlarged view of a portion (XXXXIX) shown in FIG. 48. FIG. 50 is a sectional view taken along line (XXXXX)-(XXXXX) of FIG. 5, which view shows an internal structure. FIG. 51 is an enlarged top plan view of a rotation mechanism 90. FIG. 52 is a sectional view which shows a rotation structure 91 of the rotation mechanism 90. FIG. 53 is a perspective view of the driver drill 10I shown in FIG. 46 in which a battery attachment portion 60I is rotated 90 degrees, which view shows an external appearance thereof.

The driver drill 10I of the tenth embodiment may have a rotation mechanism 90 that is attached to a lower portion of a grip housing portion 12I that is positioned on an upper side of the enlarged coupling portion 70 of the driver drill 10 of the first embodiment. The driver drill 10I of the tenth embodiment may be different from the driver drill 10 of the first embodiment described above on this point. Therefore, with regard to the driver drill 10I of the tenth embodiment, elements that are the substantially same as the first embodiment will be identified by the same reference numerals and a detailed description of such elements may be omitted. In particular, as shown in FIG. 47, the rotation mechanism 90 may be attached to the lower portion of the grip housing portion 12I. The rotation mechanism 90 may be a mechanism that allows an enlarged coupling portion 70I to rotate relative to the grip housing portion 12I. The enlarged coupling portion 70I to which a battery attachment portion 60I (60Ia, 60Ib) is attached may have a rotation axis that extends in an elongating direction of the handle portion 13 and may be held on the grip housing portion 12I such that a relative direction thereof relative to the handle portion 13 can be changed. As a result, a rotation axis about which the enlarged coupling portion 70I rotates relative to the grip housing portion 12I may extend in the longitudinal direction of the handle portion 13.

The rotation mechanism 90 may be configured to relatively rotate and displace the enlarged coupling portion 70I relative to the grip housing portion 12I in a plane determined by the longitudinal direction and the lateral direction. The rotation mechanism 90 may be composed of a rotation mechanism 91 and an engaging mechanism 93. The rotation mechanism 91 may be a mechanism that allows the enlarged coupling portion 70I to rotate relative to the grip housing portion 12I. In particular, as shown in FIG. 52, the enlarged coupling portion 70I may have an annular inward flange portion 911 that is projected upward therefrom. Further, the grip housing portion 12I may have a circumferential groove portion 912 formed in a lower portion thereof. The annular inward flange portion 911 may have an inwardly projected flange. Conversely, the circumferential groove portion 912 may have a groove into which the annular inward flange portion 911 is circumferentially fitted. Thus, the enlarged coupling portion 70I can rotate relative to the grip housing portion 12I.

The engaging mechanism 93 may have a male mechanism 95 shown in FIG. 49 and a female mechanism 96 shown in FIG. 50. The male mechanism 95 may be formed in the enlarged coupling portion 70I. As shown in FIG. 49, the male mechanism 95 may have a shaft portion 951 secured to the enlarged coupling portion 70I, an engagement member 952 rotatably supported on the shaft portion 951, and a plate spring 957 rotationally biasing the engagement member 952. The engagement member 952 may be configured to vertically rotate about the shaft portion 951. The engagement member 952 may have an engaging distal end 953 positioned opposite to a proximal end supported on the shaft portion 951. The engaging distal end 953 may be a portion that is configured to fit into engagement holes 963-967 of the female mechanism 96 which will be hereinafter described. The engagement member 952 may have a manipulating portion 954 that is formed therein between the shaft portion 951 and the engaging distal end 953. The manipulating portion 954 may be formed in an exposed portion of the engagement member 952 so as to press down the engagement member 952. Thus, the engagement member 952 rotatably supported on the shaft portion 951 may be biased upward by the plate spring 957. The plate spring 957 may have a contact portion 958 that contacts the engagement member 952 from below.

The contact portion 958 may contact the engagement member 952 from below. This may allow the manipulating portion 954 of the engagement member 952 to be operably exposed and may keep the engaging distal end 953 of the engagement member 952 fitted into the engagement holes 963-967 of the female mechanism 96. To the contrary, when the manipulating portion 954 of the engagement member 952 is pushed down, the engaging distal end 953 can be disengaged from the engagement holes 963-967 of the female mechanism 96. The female mechanism 96 may be formed in the grip housing portion 12I. As shown in FIG. 50, the female mechanism 96 may have an annular plate portion 961. The five engagement holes 963-967 may be formed in a rear portion of a circumferential periphery of the annular plate portion 961 at regular intervals. Each of the engagement holes 963-967 may have a rectangular shape to allow the engaging distal end 953 of the engagement member 952 to fit thereinto. Further, the engaging distal end 953 of the engagement member 952 can fit into each of the engagement holes 963-967. Therefore, upon relative rotation of the enlarged coupling portion 70I relative to the grip housing portion 12I, the engaging distal end 953 of the engagement member 952 can fit into one of the engagement holes 963-967 at a relative rotational position. As a result, the enlarged coupling portion 70I can be secured relative to the grip housing portion 12I at the relative position.

A condition in which the engaging distal end 953 fits into the engagement hole 965 may correspond to the relative position of the enlarged coupling portion 70I shown in FIG. 46. Conversely, a condition in which the engaging distal end 953 fits into the engagement hole 967 may correspond to the relative position of the enlarged coupling portion 70I shown in FIG. 53. Thus, the relative position of the enlarged coupling portion 70I relative to the grip housing portion 12I can be rotated 180 degrees. According to the driver drill 10I of the tenth embodiment, the substantially same effects as the driver drill 10 of the first embodiment may be produced. Further, following effects may be produced. That is, according to the driver drill 10I of the tenth embodiment, a relative direction of the battery attachment portion 60I (60Ia, 60Ib) relative to the handle portion 13 can be changed. Therefore, a position of the battery attachment portion 60I (60Ia, 60Ib) can be appropriately changed depending on use and storage of the tool.

The electrical power tool according to the present invention is not limited to the exemplified driver drill described above. That is, the electrical power tool may include an electrical driver, an electrical drill, a driver drill, a vibratory driver drill, an impact driver drill and other such devices that can be used to perform a screw tightening operation or a drilling operation while it is held in hand provided that the structure described above can be incorporated thereinto. Further, the hand held electrical power tool into which the structure described above can be incorporated may include a disk sander, a polisher and other such devices that can be used to perform grinding, sanding, polishing, glazing and other such treating. Further, the rechargeable batteries 80a and 80b used in the embodiments described above may respectively generate the electrical power of 18 V. However, the electrical power of the rechargeable batteries of the present invention is not limited to such voltages. That is, rechargeable batteries (secondary batteries) that generate the electrical power of 10 V, 14 V or other such voltages may be used. Further, the two rechargeable batteries 80a and 80b can be configured to increase a discharge capacity (a total amount of charge) of the electrical power supplied therefrom as well as a voltage of the electrical power supplied therefrom. That is, the rechargeable batteries 80 can be configured to increase the discharge capacity of the electrical power supplied therefrom instead of increasing the voltage of the electrical power supplied therefrom. Further, the rechargeable batteries can be changed to rechargeable batteries that generate the electrical power of 10 V, 14 V or other such voltages as necessary.

1. An electrical power tool comprising battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft,
wherein the battery attachment portions comprise two battery attachment portions that are juxtaposed in a longitudinal direction in which the motor shaft extends.

2. An electrical power tool comprising battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft,
wherein the battery attachment portions comprise two battery attachment portions that are positioned symmetrically with respect to an axis of the motor shaft.

3. An electrical power tool comprising battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft,
wherein the battery attachment portions comprise two battery attachment portions that are positioned such that axes lines along which the rechargeable batteries are attached thereto by slide-fitting are positioned in parallel to each other.

4. An electrical power tool comprising battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft,
wherein the battery attachment portions comprise two battery attachment portions that are positioned such that directions in which the rechargeable batteries are attached thereto by slide-fitting are respectively intersect with an axis line of the motor shaft.

5. An electrical power tool comprising battery attachment portions to which rechargeable batteries are attached by slide-fitting, a handle portion positioned above the battery attachment portions and holding the battery attachment portions, an electrical motor positioned on an upper side of the handle portion and configured to rotationally drive a longitudinally extending motor shaft, and a tool bit attaching portion positioned on a front side of the motor shaft and configured to be rotated by a rotational driving force of the motor shaft,
wherein the battery attachment portions have a rotation axis that extends in an elongating direction of the handle portion and are held on the handle portion such that a relative direction thereof relative to the handle portion can be changed.
